(19) United States
(12) Patent Application Publication
(10) Pub. No.: US 2022/0371266 A1
(43) Pub. Date: Nov. 24, 2022

(54) LIGHT PATTERNING OF SILICA NANOCAGE MATERIALS

(71) Applicant: CORNELL UNIVERSITY, Ithaca, NY (US)

(72) Inventors: Jen-Yu Huang, Ithaca, NY (US); Tangi Aubert, Ithaca, NY (US); Tobias Hanrath, Ithaca, NY (US); Ulrich B. Wiesner, Ithaca, NY (US)

(21) Appl. No.: 17/772,178

(22) PCT Filed: Nov. 2, 2020
(86) PCT No.: PCT/US2020/058599

§ 371 Date: Apr. 27, 2022

Related U.S. Application Data
(60) Provisional application No. 62/929,470, filed on Nov. 1, 2019.

(51) Int. Cl. B29C 64/153; B33Y 10/00; B33Y 70/00; B33Y 80/00; C01B 33/12

(52) U.S. Cl. CPC B29C 64/153; B33Y 10/00; B33Y 70/00; B33Y 80/00; C01B 33/12; B29K 2509/00

(57) ABSTRACT

Provided are compositions that may be referred to as photoreactive compositions or inks. The compositions may have a plurality of reactive components, which are silica nanocages with one or more photoreactive ligand(s). Also provided are methods of making an article of manufacture. Also provided are articles of manufacture and uses thereof. The article of manufacture may be formed from a composition of the present disclosure.

### CROSS REFERENCE TO RELATED APPLICATIONS

The present application claims priority to U.S. Provisional Application No. 62/929,470 filed on Nov. 1, 2019, the disclosure of which is incorporated herein by reference.

### STATEMENT REGARDING FEDERALLY SPONSORED RESEARCH OR DEVELOPMENT

This invention was made with government support under grant number 1635433 awarded by the National Science Foundation and DE-SC0010560 awarded by the Department of Energy. The government has certain rights in the invention.

### BACKGROUND OF THE DISCLOSURE

Additive manufacturing techniques such as three-dimensional (3D) printing have emerged as an enabling platform for the fabrication of highly engineered superstructures, covering a wide range of materials and applications, from metals to biological tissues. The convergence of 3D printing techniques and nanomaterials is generating a compelling opportunity space to create advanced materials with multiscale structural control and hierarchical functionalities. While most nanoparticles consist of a dense material, less attention has been payed to 3D printing of nanoparticles with intrinsic porosity. Among 3D printing techniques, digital light processing (DLP) has become a method of choice due to its easy implementation and great versatility. This technique uses an array of digital micromirror devices that equip relatively simple video projectors as dynamic masks. When combined with photosensitive resins, it allows for the rapid layer-by-layer building of macroscopic objects with arbitrary shapes and resolutions down to the micrometer scale. Recent advances in materials science provide an extensive library of nano-sized building blocks, enabling printed materials and devices with programmable optical, magnetic, plasmonic, and catalytic properties. For light-based 3D printing purposes, nanoparticles and nanomaterials are typically used as fillers, blended with polymeric binders. These composites are, however, often limited to relatively low weight fractions of the active filler. This in turn may limit the intrinsic added value of the nano-sized components. To fully exploit the potential of the combination of nanomaterials and 3D printing techniques, we developed a new class of functional inks based on a photoresponsive ligand on inorganic core (PLIC) design. This approach leverages prior nanomaterials research with its development of a large variety of nanosized building blocks offering a wide range of properties. Advances in our understanding of the surface chemistry of nanostructured materials have enabled their functionalization with tailored surface ligands. The confluence of nanomaterials synthesis and advanced additive manufacturing methods now allows materials scientists and engineers to combine nanoscale properties of matter with the micro- and macroscale structural control offered by 3D printing techniques.

Three-dimensional (3D) printing techniques, or additive manufacturing technologies, have emerged as an enabling platform for the bottom-up fabrication of advanced functional superstructures covering a wide range of materials and applications, from metals and ceramics to biological tissues and organs. Among these techniques, digital light processing (DLP) has become a versatile choice, allowing for the printing of polymeric or hybrid materials and employing simple commercial video projectors. This technique makes use of digital micromirror devices (DMD) to generate pre-programmed UV/blue light shapes in a plane. When combined with photosensitive resins, this allows for the rapid layer-by-layer building of macroscopic objects with arbitrary shapes and resolutions down to the micrometer scale. Recent advances in materials science provide an extensive library of nano-sized building blocks, enabling printed materials and devices with programmable optical, magnetic, plasmonic, and catalytic properties. For light-based 3D printing purposes, nanoparticles and nanomaterials are typically used as fillers, blended with polymeric binders. These composites are, however, often limited to relatively low weight fractions of the active filler. This in turn may limit the intrinsic added value of the nano-sized components.

### SUMMARY OF THE DISCLOSURE

The present disclosure provides compositions, methods of making the compositions and methods of using the compositions. The present disclosure also provides articles of manufacture.

In an aspect, the present disclosure provides compositions. The compositions may be referred to as photoreactive compositions or inks.

In various examples, a composition comprises a plurality of reactive components (which may be referred to individually as a monomer or a photoresponsive ligand on inorganic core (PLIC)), the individual reactive components comprising a silica nanocage and one or more photoreactive ligands (e.g., methacrylate group(s), such as, for example, alkylmethacrylate group(s)) (e.g., 1 to 1000 (1 to 50, 1 to 100, 1 to 500, 2 to 50, 2 to 100, 2 to 500, 2 to 1000, 3 to 50, 3 to 100, 3 to 500, or 3 to 1000 photoreactive ligands), including all integer number of photoreactive ligands and ranges therebetween), which may provide colloidal stability to the composition. The reactive components may be present at 1-70 wt. % (e.g., 40-70 or 50-70 wt. %) (based on the total weight of the composition), including all 0.1 wt. % values and ranges therebetween.

In an aspect, the present disclosure provides methods of making articles of manufacture. A method may be an additive manufacturing method. An article of manufacture of the present disclosure may be made by a method of the present disclosure. A method may provide control over the porosity and/or shape of an article of manufacture, which may be a printed article of manufacture, as formed (e.g., in the absence of any post-formation (e.g., post-printing) process(es)).

In an aspect, the present disclosure provides articles of manufacture. An article of manufacture may be a 3D article of manufacture. A method may be an additive manufacturing method. An article of manufacture of the present disclosure may be made by a method of the present disclosure and/or using a composition of the present disclosure. An article of manufacture may be in the form of a monolithic structure, a free-standing film, or a film disposed on at least a portion of or all of a substrate, a structure anchored in a confined environment (e.g. of a microfluidic device) such as, a tube or channel. For example, the mesoporous material can be fabricated with controlled pore size distribution and macroscopic shape within the flow channel of a microfluidic device, which may be used for bio separation and other processes. A three-dimensional (3D) printed article of manufacture according may be porous (e.g., mesoporous, microporous, or a combination thereof), optionally, wherein at least a portion or all of the pores are interconnected (e.g., the article of manufacture comprises a network of polymerized reactive components and/or at least a portion or all of the silica nanocages are mesoporous and/or the silica nanocages are oriented such that the form a microporous network, or a combination thereof. A three-dimensional (3D) printed article of manufacture may have hierarchical porosity. Non-limiting examples of articles of manufacture are provided herein.

An article of manufacture may be in the form of (e.g., has a macroscopic shape of) a monolithic structure, a free-standing film, or a film disposed on at least a portion of or all of a substrate, a structure anchored in confined environment such as, tubes or channels (e.g., of a microfluidic device).

In an aspect, the present disclosure provides uses of articles of manufacture of the present disclosure. The articles of manufacture may be used in various applications. Non-limiting examples of uses of the articles of manufacture are provided herein.

### BRIEF DESCRIPTION OF THE FIGURES

For a fuller understanding of the nature and objects of the disclosure, reference should be made to the following detailed description taken in conjunction with the accompanying figures.

FIG. 1 shows direct printing of mesoporous parts. Illustration (a) and TEM image (b) of silica cages functionalized with methyl methacrylate groups (inset in a: illustration of a cage strut partially wrapped by the surfactant micelle surface). (c) TEM image of a piece of a printed part (inset: zoom in, arrows point to clearly visible cage structures, scale bar 10 nm). (d) Photograph of a pattern printed on a glass substrate with dye-functionalized cages (inset: photography under UV illumination). (e) Photograph of parts printed with silica cages with high (left) and low (right) methyl methacrylate surface coverage. (f) Nitrogen sorption isotherms of parts printed with parent high and low methyl methacrylate coverage materials, and with mixed parent materials (inset: zoom in to the hysteresis range).

FIG. 2 shows positioning of functionalities within printed structures. Illustrations (a, b, c) and photographs (d, e, f) of the spatially controlled deposition of silica cages with different functional groups and the selective binding of organic dyes. Two independent layers of cages functionalized with either thiol or amine groups are printed successively in a shifted checkerboard pattern (a, d). The pattern is then exposed to a mixture of TMR-mal and Cy5-NHS dyes (b, e), which bind selectively to the thiol and amine functionalized tiles, respectively (c, f). Between each step, the pattern was washed with methanol.

FIG. 3 shows internal 3D printing. (a, b, c) Illustration of the process of printing silver within a primary part printed with porous silica cages. First, a block of silica cages without additional functionalization is printed (a). The block is immersed in a solution of silver nitrate and photoinitiators. A light pattern in the shape of slabs is then projected onto this block (b), resulting in the localized reduction of Ag⁰ ions into Ag⁰ (c). (d) Photograph of the resulting block of silica cages exhibiting three slabs of metallic silver. Backscattered electron based SEM image (e) and EDS map (f) of a silver slab embedded in the porous silica matrix.

FIG. 4 shows contact angle measurements of a water droplet on a cover glass slide, as received (a), after 1 day in 0.2 M NaOH (b), and after functionalization with methacrylate silane (c). The NaOH treatment generates surface silanol groups resulting in a highly hydrophilic surface on top of which the water droplet fully spreads with a contact angle close to 0° (b). This activated surface promotes the bonding of methacrylate-silane, resulting in a hydrophobic surface as evidenced by an increase of the contact angle (c). The methacrylate groups on the surface can readily bound with the functionalized cages during the 3D printing process, enhancing the adhesion of printed parts on the substrate.

FIG. 5 shows confocal microscopy image (a) and 3D view (b) of a free-standing part with honeycomb structure (sample with high ligand coverage before calcination). (c) Line profiles across a strut of the honeycomb structure as a function of the ligand coverage and thermal treatment.

FIG. 6 shows photographs and nitrogen sorption measurements of parts printed from cages with high ligand coverage (a, b, c) and low ligand coverage (d, e, f). The comparison of the photographs before (a, d) and after (b, e) calcination evidences that the macroscopic shape of the parts is preserved after calcination (at the exception of a shrinkage factor).

FIG. 7 shows EDS analysis of the cross section from a silver slab printed within a silica part. The Ag map is overlaid with the secondary electron image.

FIG. 8 shows (a) rheology measurements, including storage modulus (G′) and loss modulus (G″), of the PLIC ink under UV irradiation (inset: zoom-in to the region around the gel point). (b) Photograph of a multilayer 3D structure printed from the PLIC ink.

FIG. 9 shows high-resolution printing. Projection pattern (a) and optical microscopy image (b) of a print at single pixel resolution (dotted lines outline the mirrors of the DMD). (c) SEM image of a print at single pixel resolution.

FIG. 10 shows microstructure control. Photograph of a part printed with a greyscale pattern (insets: greyscale pattern (top) and side view (bottom) of the part).

FIG. 11 shows accessibility of functionalities within printed structures. A ship pattern made of amine and methacrylate functionalized cages was printed between two layers of plain cages only functionalized with methacrylate ligands and forming a bottle shape (a). In the resulting part (b), the “ship in the bottle” is invisible. After immersion in a Cy5-NHS solution, however, the dyes penetrate the structure and bind selectively to the amine groups, revealing the ship after additional washing (c).

FIG. 12 shows (a) FTIR transmission spectra of the neat methacrylate silane and the as-prepared methacrylate functionalized silica cage ink without photoinitiator (inset: chemical structure of 3-(trimethoxysilyl)propyl methacrylate, the methacrylate silane), showing the characteristic absorption bands from the stretching vibration of the carbonyl, C═O, group at 1720 cm⁻¹, and the stretching vibration of the C═C double bond at 1630 cm⁻¹. (b) FTIR absorption spectra of the main C═O and C═C bands before (i.e., ink without photoinitiator, line, same as curve in a), and after curing (i.e., printed part grounded into a powder). In (b) the absorption spectra were normalized based on the integrated absorbance (rather than simple peak intensity) of the C═O band (from 1660 cm⁻¹ to 1780 cm⁻¹) to account for the broadening of the band. The C═C absorbance band was then integrated (from 1550 cm⁻¹ to 1650 cm⁻¹) and the values are reported in the inset of (b), exhibiting a decrease as expected from polymerization.

FIG. 13 shows an example of a projection pattern (a), photograph of the resulting printed part (b), and overlay of the two (c).

FIG. 14 shows TEM images of parts printed from cages with high ligand coverage (a, b) and low ligand coverage (c, d), before (a, c) and after (b, d) calcination.

FIG. 15 shows absorption spectrum of TPO at 0.7 mM in ethanol:toluene (1:1 vol %).

FIG. 16 shows viscosity of the silica cage ink and a commercial 3D printing resin (Autodesk Clear Resin) as a function of shear rate.

FIG. 17 shows (a, b, c) photographs of a 3D printed structure with hanging features (inset in a: 3D model of the structure).

FIG. 18 shows transmission spectrum from a set-up with 1 cm pathlength through the as-prepared ink of the methacrylate functionalized silica cages without photoinitiator (inset: zoom-in to the DLP projector spectral range).

FIG. 19 shows greyscale pattern (a) and photograph of the resulting printed part (b). c, Zoom in to the region highlighted with a yellow square in b.

FIG. 20 shows illustration of different options for the implementation of internal 3D printing in either a top-down (a, b, c, d) or bottom-up (e, f, g, h) projection setup. In top-down, the host structure can be fully printed first (a, b), then progressively re-immersed in the vat containing the precursor solution of the guest material (c, d). In bottom-up, after printing a layer of the host structure (e, f), the vat ink is replaced for the printing of guest material within this layer (g), and changed again for the next host structure layer (h).

### DETAILED DESCRIPTION OF THE DISCLOSURE

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value).

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent, trivalent, and the like, radicals). Illustrative examples of groups include:

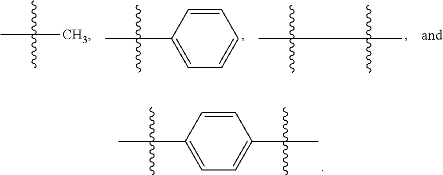

The present disclosure provides compositions, methods of making the compositions and methods of using the compositions. The present disclosure also provides articles of manufacture.

In an aspect, the present disclosure provides compositions. The compositions may be referred to as photoreactive compositions or inks.

In various examples, a composition comprises a plurality of reactive components (which may be referred to individually as a monomer or a photoresponsive ligand on inorganic core (PLIC)), the individual reactive components comprising a silica nanocage and one or more photoreactive ligands (e.g., methacrylate group(s), such as, for example, alkylmethacrylate group(s)) (e.g., 1 to 1000 (1 to 50, 1 to 100, 1 to 500, 2 to 50, 2 to 100, 2 to 500, 2 to 1000, 3 to 50, 3 to 100, 3 to 500, or 3 to 1000 photoreactive ligands), including all integer number of photoreactive ligands and ranges therebetween), which may provide colloidal stability to the composition. The reactive components may be present at 1-70 wt. % (e.g., 40-70 or 50-70 wt. %) (based on the total weight of the composition), including all 0.1 wt. % values and ranges therebetween.

The photoreactive ligands are bound to the silica nanocage core by one or more chemical bonds (e.g., covalent bond(s), coordinate covalent bond(s), ionic bond(s), hydrogen bond(s), or the like, or a combination thereof). A photoreactive ligand may react when exposed to photons or electrons. The composition may be a colloidal suspension of the reactive components. The composition may have desirable viscosity (e.g., the composition may be a low viscosity liquid).

A mixture of reactive components may be used. For example, the photoreactive ligands comprise one or more chelating group and one or more photoreactive group. Non-limiting examples of chelating groups include thiol/thiolate groups, carboxylic acid/carboxylate groups, amines, silanol groups, and the like, and combinations thereof. Non-limiting examples of photoreactive groups include carbon-carbon double bonds (which may be terminal groups), acrylate groups, alkyne groups, thiol groups, ester group, heterocyclic group, epoxy group (e.g., oxirane) and the like, and combinations thereof.

The silica nanocages are discrete nanoscale structures. The silica nanocages may be referred to nanoparticles, particles, cage-like structures, nanocages, or cages. The silica nanocages may have cage-like polyhedral shapes, which may have icosahedral symmetry. The silica nanocages comprise a plurality of polygons that form the silica nanocage. The polygons may all have the same shape or two or more of the polygons have different shapes. For example, the silica nanocages comprise the following surface polygons (where the exponent describes how often a polygon appears on the surface of the cage): 3³4³, 4⁴5⁴4³5⁶6³, 3³4₃5⁹, 5¹² (dodecahedral), 5¹²6², 4⁶6⁸, 5¹²6³, 5¹²6⁴, 4³5⁹6²7³, 5¹²6⁸, 5¹²6²⁰ (buckyball), or the like.

The silica nanocages include, in various examples, a series of desirably symmetric (e.g., highly symmetric) cage structures at the nano-scale (instead of atomic scale structure in molecular cages). The silica nanocages may exhibit highly symmetric cage structures, including, but not limited to, dodecahedral, icosahedral, cubic, hexanol, tetrahedral, octahedral, buckyball-like cages, and the like.

Silica nanocages may have various sizes. The silica nanocages may have a size, e.g., a longest dimension, which may be a longest linear dimension, which may be a diameter, of less than 50 nm (e.g., of less than 30 nm). The silica nanocages may have a size, e.g., a longest dimension, which may be a longest linear dimension, which may be a diameter, of 5 to less than 50 nm, 5 to less than 30 nm, 5 to 20 nm, or 5 to 15 nm. For example, the silica nanocages may have a size, e.g., a longest dimension, which may be a longest linear dimension, which may be a diameter, of less than 5 nm to slightly more than 20 nm or slight more than 10 nm. The size may or may not include any surface functional groups of a silica nanocage.

Without intending to be bound by any particular theory, it is considered that the silica nanocage nanostructures are flexible and can deform to pass through channels having a width smaller than the silica nanocage size. It is considered that silica nanocages having a size (e.g., longest dimension) greater than would typically allow renal clearance from an individual by the kidneys are cleared from an individual by the kidneys.

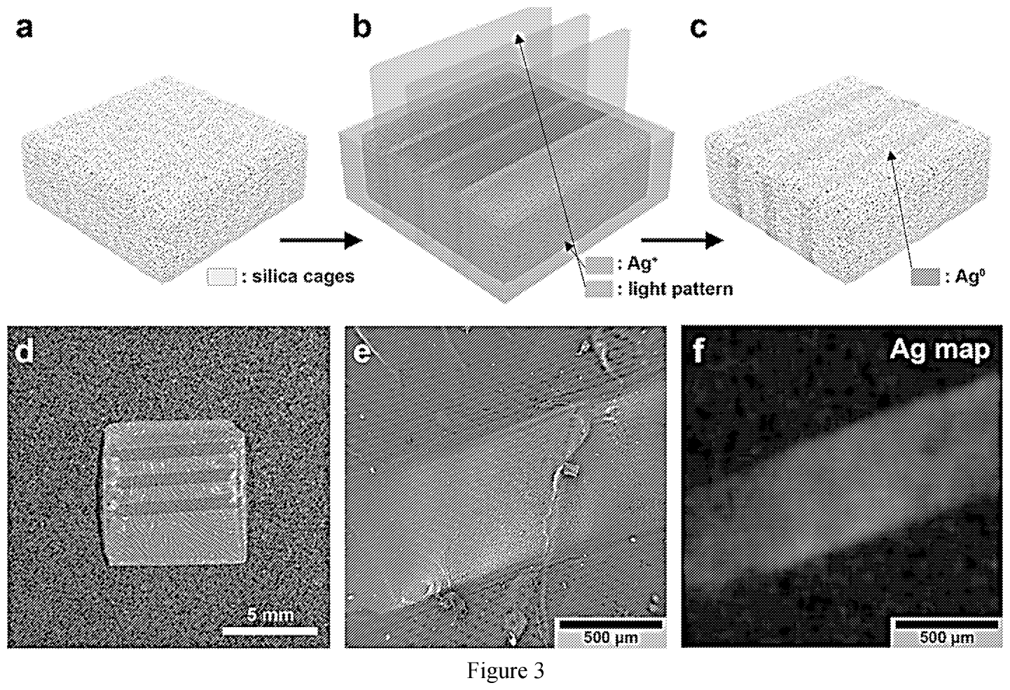

The silica nanocages may have several structural features. These features may include an interior, a plurality of apertures (which may be referred to as “windows” or “open windows”), arms (which may be referred to as “struts” or “edges”), and vertices. Examples of structural features are shown in FIG. 3.

The silica nanocages may have a fully empty interior. The apertures of the silica nanocage may connect the interior of the silica nanocage to the outside environment. That is, material from the outside environment may pass through an aperture into the interior of the silica nanocage. The silica nanocages have fully empty interior, while there are open windows on the cages connecting the inside and outside.

The point at which several arms (edges) meet is referred to as a vertice. The vertices of the silica nanocages may have a longest linear dimension (e.g., a diameter) about 1 to about 5 nm, including every 0.1 nm value and range therebetween. The arms connecting two nearby vertices of the silica nanocages may have a longest linear dimension (e.g., diameter) of less than 1 to about 3 nm or less than or equal to 1 to about 5 nm. For example, the struts of the silica nanocages are around 2 nm thick and only contains a few atoms across the cross-section.

A silica nanocage has a plurality of apertures. The apertures can have various shapes. The silica nanocage may have apertures having all the same shape or have apertures having two or more shapes. The apertures may independently have a size (e.g., a longest dimension in a plane defining the aperture), such as, for example, a diameter, of 1 to 10 nm, including all 0.1 nm value and ranges therebetween. The apertures may have a size of 2 to 7 nm. The apertures (i.e., windows) of the silica nanocages may have a longest linear dimension (e.g., a diameter) of about 1 nm to about 5 nm, including every 0.1 nm value and range therebetween. For example, in a nanocage, a portion of the vertices and a portion of the arms define a polygon and an aperture defines at least a portion of that polygon.

The size of the silica nanocages may be determined by both the geometry of cage structure and the composition of materials, while the aperture (i.e., window) sizes may be similar or different form the cages containing same material composition but with different structure geometries.

In an example, dodecahedral silica nanocages have an average diameter around 12 nm. In comparison, silica nanocages with the more complex geometries, such as buckyballs, are substantially bigger, while the silica nanocages with the simpler geometries, such as tetrahedral cages, are smaller.

The silica nanocages can have desirable surface area. The silica nanocages may have a surface area of 500 to 800 m²/g. The surface area may be determined by methods known in the art. In an example, the surface area is determined by BET analysis of nitrogen sorption isotherms.

The silica nanocages can be functionalized using various methods (e.g., as described herein). For example, the silica nanocages are functionalized by reaction with an alkoxysilyl (e.g., mono-, di-, tri-alkoxysilyl group, or a combination thereof) functionalized acrylate or methacrylate (e.g., trimethoxysilylalkylmethacrylate). At least a portion of a surface (e.g., at least a portion of an exterior surface and/or at least a portion of an interior surface of the silica nanocages may be functionalized (e.g., covalently functionalized and/or non-covalently functionalized).

The silica nanocages may be selectively functionalized. The functionalization may be the same for the interior surface and exterior surface of the silica nanocages or may be different for the interior surface and exterior surface of the silica nanocages.

The interior (inner) and exterior (outer) surface of the silica nanocages may be selectively modified with desired functional groups via both covalent and non-covalent interactions for different applications.

The silica nanocages may be further functionalized. For example, the exterior surface of the silica nanocages can be covalently functionalized with polyethylene glycol for improving bio-compatibility. The silica matrix of the silica nanocages may be covalently labeled with a fluorescent dye to endow the cages with fluorescence properties.

Silica nanocages may be produced through self-assembly. Briefly, under the optimized synthesis conditions, silica precursors self-assemble into the highly symmetric cage structures on the surface of self-assembled surfactant micelles. The surfactant micelles may be structure directing.

Non-limiting examples of silica nanocages and methods of making silica nanocages are described in International Patent Application PCT/US19/26411, filed Apr. 8, 2019, the disclosure of which with regard to silica nanocages and methods of making silica nanocages is incorporated herein by reference.

The silica nanocages may be functionalized (e.g., as described herein) with one or more groups that render the silica nanocages printable. Non-limiting examples of groups that render the silica nanocages printable are carbon-carbon double bonds that can be photopolymerized. In a non-limiting example, a silica nanocage is functionalized with one or more acrylate groups (e.g., methacrylate groups, such as, for example, alkyl methacrylate groups), alkenyl groups (e.g., alkene ligands), and the like, and combinations thereof.

Various acrylate groups and combinations of acrylate groups may be used. Non-limiting examples of acrylate groups include groups formed from the following: acrylic acid, methacrylic acid, mono-2-(methacryloyloxy)ethyl maleate, 2-carboxyethyl acrylate, 3-sulfopropyl acrylate potassium salt, [2-(acryloyloxy)ethyl]trimethylammonium chloride solution, 2-chloroethyl acrylate, 3-chloro-2-hydroxypropyl methacrylate, 2-aminoethyl methacrylate hydrochloride, ethylene glycol methacrylate phosphate, 3-(trimethoxysilyl)propyl methacrylate, silylated acrylate, analogs thereof, which may be functionalized analogs, derivatives thereof, or the like, or a combination thereof.

Various alkenyl ligands and combinations thereof may be used. Non-limiting examples of alkenyl ligands (e.g., alkenyl groups) include groups formed form the following 2-propenoic acid, pentenoic acid, hexenoic acid, 2-methyl-4-pentenoic acid, 7-octenoic acid, allicin, allin, analogs thereof, which may be functionalized analogs, derivatives thereof, or the like, or a combination thereof.

The photoreactive ligands may be functionalized. One, more, or all of the photoreactive ligands may be functionalized. The photoreactive ligand(s) may be functionalized by reacting one or more of the polymerizable groups of the polymerizable ligands. The photoreactive group(s) may be functionalized with various groups. The photoreactive groups may be functionalized with groups formed from amino acids (such as for example, cysteine), proteins, peptides, biomolecule groups (e.g., vitamins), glutathione, biotin, nitrilotriacetic acid (NTA), iminodiacetic acid (IDA), polyadenylic acid (poly (A)), nucleotide, phospho-amino acid, boronic acids, or the like, or a combination thereof.

The photoreactive groups may be functionalized using various chemistries. For example, a photoreactive group is functionalized via one or more thiol-ene reactions, Click reactions, NHS amine reactions, or the like. Other non-limiting examples of functionalization chemistries include vinyl, epoxy, and urethane-based polymerizations.

Compositions of the present disclosure may further comprise one or more photoinitiator(s). Photoinitiator(s) may be present at 1-10 wt. % (e.g., 0.1-10, 1-15%, or 1-2 wt. %) (based on the total weight of the composition). In various examples, a photoinitiator is a DOLFIN photoinitiator. In various examples, the composition further comprises one or more photoinitiator(s) chosen from free radical photoinitiators, cationic photoinitiators, nanoparticle-based photoinitiators, photo-acid generators, and combinations thereof. For example, photoinitiator(s) is/are chosen from free radical photoinitiators (e.g., diphenyl(2,4,6-trimethylboenzoyl phosphine oxide), phosphine oxide, phenyl bis(2,4,6-trimethyl benzoyl), bis [2,6-difluoro-3-(1H-pyrrol-1-yl) phenyl]titanium, anthraquinone-2-sulfonic acid, 4-benzoylbiphenyl, 4,4′-bis(diethylamino) benzophenone, 2-benzyl-2-(dimethylamino)-4′-morpholinobutyrophenone, 4,4′-bis(dimethylamino) benzophenone, 4-(dimethylamino) benzophenone, 2-Hydroxy-2-methyl-1-phenyl-propan-1-one, or a combination thereof); cationic photoinitiators (e.g. diphenyliodonium hexafluorophosphate, (4-Iodophenyl)diphenylsulfonium triflate, (4-tert-Butylphenyl)diphenylsulfonium triflate, or a combination thereof); nanoparticle based photoinitiators (e.g., quantum dots, zinc oxide nanoparticles, or a combination thereof); photo-acid generators (e.g. (4-methylthiophenyl) methyl phenyl sulfonium triflate, sodium 1,2,3,4-thiatriazole-5-thiolate, tris(diphenyliodonium), 9-hydroxy-pyrene-1,4,6-trisulfonate, or a combination thereof); and combinations thereof.

A composition of the present disclosure may further comprise one or more crosslinker(s). A crosslinker may provide one or more of stability, mechanical strength, or the like, to an article of manufacture and/or provide a composition with increased reaction rate (e.g., print speed), relative to a composition with the same composition except for the crosslinker(s), in an additive manufacturing method (e.g., a method of the present disclosure). Crosslinker(s) is/are present at 0-60 wt. % (based on the total weight of the composition) (e.g. 0.1 to 60 wt. %), including all 0.1 wt. % values and ranges therebetween. The crosslinker(s) may comprise functional groups that react in a thiol-ene reaction, a Click reaction, or the like. Non-limiting examples of crosslinker(s) include di- to multi-thiol groups (e.g. benzene dithiol, poly(ethylene glycol) dithiol, 1,3,4-thiadiazole-2,5-dithiol, biphenyl-4,4′-dithiol), di- to multi-acrylate groups (e.g. poly(ethylene glycol) dicrylate, 1,3-butanediol diacrylate, 1,6-hexanediol diacrylate, bisphenol A ethoxylate diacrylate, ethylene glycol diacrylate, di(ethylene glycol) diacrylate, tri(ethyleneglycol) diacrylate, trimethylol propane triacrylate), and the like, and combinations thereof. In various examples, mono-, bi-, and multi-alkene (e.g., 1,3,5-triallyl-1,3,5-triazine-2,4,6(1H,3H,5H)-trione) may be functionalized with thiol groups. Additional examples of crosslinkers include, but are not limited to, vinyl groups, epoxy groups, and urethane-based groups (e.g., crosslinking may be achieved through vinyl-, epoxy-, or urethane-based chemistries, or a combination thereof).

A composition of the present disclosure may further comprise one or more various oligomer(s). The molecular weight of the oligomers may have a molecular weight of 100 to 5000 amu, including all amu values and ranges therebetween. The oligomer(s) is/are present at 0-90 wt. % (based on the total weight of the composition), including all 0.1 wt. % values and ranges therebetween (e.g. 0.1 to 90 wt. %). The upper limit of an oligomer's molecular weight may depend on its chemical nature and may equal the molecular weight of a segment, at which the substance starts demonstrating one or more or all of superelastic strain, forced rubber-like elasticity, or the like, or other properties typically inherent to polymers. For example, polar and rod-like chain oligomers have a greater range of potential molecular weight values (e.g., up to about 15,000 amu) than nonpolar oligomers (e.g., up to 5,000 amu). Non-limiting examples of oligomers include oligomers (e.g., oligomers having a molecular weight of 50 to 2500 g/mol) and polymers of epoxy acrylates, aliphatic urethane acrylates, aromatic urethane acrylates, ester acrylates, acrylic acrylates, and combinations thereof.

A composition of the present disclosure may further comprise various solvents. A solvent may be one or more organic solvent(s) (e.g., aromatic solvents, (such as, for example, benzene, toluene, xylene, and the like), aliphatic solvents (such as, for example, alkanes, cycloalkanes, and the like), polyethers or oligoethers (such as for example, propylene glycol monomethyl ether acetate, and the like), aprotic solvents (such as, for example, N-methyl-2-pyrrolidone, and the like), halogenated solvents (such as chloroform, dichloromethane, and the like), alcohols (such as, for example, isopropanol, butanol (e.g., n-butanol, t-butanol, isobutanol), pentanol, and the like), long chain alkenes (such as, for example, octadecene and the like), and combinations thereof).

A composition may further comprise an absorbing dye. The absorbing dye may have a known photocatalytic degradation, such as, for example, Reactive Orange 16, Orange Orasol G, and the like. Without intending to be bound by any particular theory, it is considered such a dye may increase resolution.

In an aspect, the present disclosure provides methods of making articles of manufacture. A method may be an additive manufacturing method. An article of manufacture of the present disclosure may be made by a method of the present disclosure. A method may provide control over the porosity and/or shape of an article of manufacture, which may be a printed article of manufacture, as formed (e.g., in the absence of any post-formation (e.g., post-printing) process(es)).

In various examples, a method (which may be an additive manufacturing method) of forming an article of manufacture, which may be a three-dimensional (3D) article of manufacture, comprises: exposing a first layer or a selected portion of a first layer of precursor (which may be a composition of the present disclosure (e.g., a composition of any one of the preceding claims)) to electromagnetic radiation (e.g., light, which may be provided by a laser and/or may be spatially coherent) such that a plurality of precursors react and a first layer of a material (which may be i) a polymerized material and/or ii) separated from the unreacted precursor and/or iii) continuous or discontinuous)) is formed; optionally, forming a second layer of precursor, optionally, exposing the second layer or a selected portion of the second layer of precursor to electromagnetic radiation (e.g., light, which may be provided by a laser and/or may be spatially coherent) such that a plurality of precursors in the second layer of precursor react and a second layer of a material (which may be i) a polymerized material and/or ii) separated from the unreacted precursor and/or first layer of material and/or iii) continuous or discontinuous)) is formed, and optionally, repeating the forming and exposing (e.g., the forming a layer of precursor and exposing the layer or a portion thereof to electromagnetic radiation such that a plurality of precursors react to form a layer of material as described herein) a desired number of times, where the article of manufacture (e.g., an article of manufacture comprising a plurality of layers of material) is formed. A method may include one or more processes typically used in traditional photolithographic processes (e.g., depositing/coating, patterning, development, etc.) or additive manufacturing processes (e.g., extrusion, injection, vat stereolithography, and/or two-photon lithography). A method may further comprise calcining the article of manufacture to remove the all or substantially all of the carbon. Non-limiting examples of methods of making articles of manufacture, which may use compositions of the present disclosure, are provided herein.

In various examples, the source of electromagnetic radiation is provided by a laser, a DLP projector, an LCD projector, an LCD screen, a UV light source, or the like. The light source may be spatially coherent (such as in the case of a laser) or collimated (such as in the case of projection light). In various examples, in the case of masking (such as, for example, screen or conventional photolithography), light is neither collimated nor spatially coherent and the light is close to the patterned area.

In various examples, the first layer of material or all of the layers of material is/are translated relative to a surface of the precursor. In various examples, at least one or each layer of precursor and/or material has a thickness of monolayer to 10 cm (e.g., 2 nm to 500 nm, 2 nm to 2 cm). In various examples, the method further comprises removing the first layer or all of the layers of material from the remaining (e.g., unreacted) precursor material that is unaffected by the energy.

The forming and the exposing may be repeated. For example, the forming and the exposing are repeated 1 to 100, 1 to 1000, 1 to 10,000, 1 to 100,000 times, or 1 to 500,000 times. The forming and the exposing may be repeated continuously or performed in batched mode. The forming and the exposing may be repeated until the entire structure is completed (e.g., printed to completion such that the desired object is formed). One or more or all of the exposing and/or forming and exposing may be carried out in pre-selected pattern (e.g., using a direct-write method, a lithographic method, digital light processing method, stereolithography method, or the like). One or more or all the exposing and/or forming and exposing is/are carried out using a 3D printer, stereolithography, drop coating, spray coating, dip coating, inkjet printer, extrusion, electrospinning, or the like, or a combination thereof.

Various forms of electromagnetic energy may be used during the exposing. The electromagnetic radiation may be infrared light, visible light, ultraviolet light, e-beam, or x-ray light. The electromagnetic radiation may have a wavelength of visible light (400-700 nm), Ultraviolet A (315-400 nm), Ultraviolet B (280-315 nm) and part of Ultraviolet C (190-280 nm) or e-beam. The selection of the wavelength(s) of electromagnetic radiation may be based on the particular photoinitiator(s) used.

A method may provide desirable control over the formation (e.g., printing process). A method may provide one or more of control (e.g., using a spatial light modulator) of macroscopic shape of the article of manufacture (e.g., provide user defined shapes such as, for example, stars, cylinders, which may be in devices such as, for example, microfluidic devices, artificial leaves, or the like), a combination of porosity (e.g., hierarchical porosity), or the like.

In various embodiments, the inter-particle porosity (by varying the light dose) can be controlled locally. This effect can be varied within the same layer of an object. The porosity and size may be different in any point of the object independently from the surrounding pores.

A method is typically carried out at room temperature (e.g., 18 to 25° C.). In contrast, prior art methods, which may use solid powders, normally require high temperature (e.g., up to 700° C.). A method may not require post-processing thermal annealing. This may have implications in the manufacturing of structures and devices with a low thermal budget.

The method may further comprise functionalizing at least a portion of or all of the article of manufacture (e.g., by reacting one or more unreacted polymerizable ligands). One or more photoreactive ligand(s) is/are reacted with a precursor (e.g., a suitably functionalized amino acid, glutathione, biotin, nitrilotriacetic acid (NTA), iminodiacetic acid (IDA), polyadenylic acid (poly (A)), nucleotide, phospho-amino acid, boronic acids, and the like) forming an amino acid group (such as for example, cysteine group), glutathione, biotin, nitrilotriacetic acid (NTA), iminodiacetic acid (IDA), polyadenylic acid (poly (A)), nucleotide, phospho-amino acid, boronic acids, and the like, or a combination thereof.

In various examples, the method further comprises contacting the article of manufacture with a solvent (e.g., organic solvent, such as, toluene, propylene glycol monomethyl ether acetate, dichloromethane, acid, such as acetic acid, methacrylic acid, or a combination thereof) and/or drying (e.g., vacuum drying) the article of manufacture. The method may further comprise exchanging the article of manufacture with a solvent (e.g., water, alcoholic solvent, such as, IPA, methanol, ethanol, or a combination thereof) and/or freeze-drying the solvent exchanged article of manufacture. The method may further comprise drying (e.g., vacuum drying) (e.g., removing any unreacted precursor, solvent, and the like) the article of manufacture in a near critical (e.g., a supercritical) gas (e.g., near/supercritical carbon dioxide, nitrogen, or the like).

A method may further comprise hard curing. Hard curing may be utilized when using resin-based additive manufacturing. Hard curing may be performed in a UV oven.

A method of the present disclosure may be performed such that an article of manufacture of the present disclosure is printed within the pore(s) of an article of manufacture made by a method of the present disclosure. The porosity of the first formed article of manufacture may serve as a scaffold for the subsequent printing of a second article of manufacture directly within the first.

In an aspect, the present disclosure provides articles of manufacture. An article of manufacture may be a 3D article of manufacture. A method may be an additive manufacturing method. An article of manufacture of the present disclosure may be made by a method of the present disclosure and/or using a composition of the present disclosure. An article of manufacture may be in the form of a monolithic structure, a free-standing film, or a film disposed on at least a portion of or all of a substrate, a structure anchored in a confined environment (e.g. of a microfluidic device) such as, a tube or channel. For example, the mesoporous material can be fabricated with controlled pore size distribution and macroscopic shape within the flow channel of a microfluidic device, which may be used for bio separation and other processes. A three-dimensional (3D) printed article of manufacture according may be porous (e.g., mesoporous, microporous, or a combination thereof), optionally, wherein at least a portion or all of the pores are interconnected (e.g., the article of manufacture comprises a network of polymerized reactive components and/or at least a portion or all of the silica nanocages are mesoporous and/or the silica nanocages are oriented such that the form a microporous network, or a combination thereof. A three-dimensional (3D) printed article of manufacture may have hierarchical porosity. Non-limiting examples of articles of manufacture are provided herein.

An article of manufacture may be in the form of (e.g., has a macroscopic shape of) a monolithic structure, a free-standing film, or a film disposed on at least a portion of or all of a substrate, a structure anchored in confined environment such as, tubes or channels (e.g., of a microfluidic device).

The article of manufacture may be porous (e.g., microporous (e.g., having pores with a size (e.g., at least one dimension) of 0.1-2 nm), mesoporous (e.g., having pores with a size (e.g., at least one dimension) of 2-50 (e.g., 20-50 nm)), macroporous, or a combination thereof) (e.g., comprises intra-particle (silica nanocage struts and silica nanocage core) micropores and/or mesopores) and/or inter-particle (gap between adjacent nanocages) macropores), where at least a portion or all of the pores may be interconnected.

The article of manufacture may comprise a network of polymerized reactive components. For example, at least a portion of or all of the article of manufacture has a microporous network, a mesoporous network, a macroporous network, or a combination thereof. An article of manufacture may have a desirable distribution (e.g., relative ratio) of pore sizes (e.g., micropores, mesopores, macropores, or a combination thereof), which may be based on total pore volume of, if present, micropores and/or mesopores and/or macropores. For example, an article of manufacture having macropores may have at least one dimension (e.g., a height) as measured in a plane perpendicular to an axis of the pore) of 500 microns to 1 micron (e.g., 200 microns to 1 micron or 100 microns to 1 micron), and/or at least a portion of or all of the silica nanocage cores are microporous and/or mesoporous (e.g., microporous and/or mesoporous as defined by IUPAC).

The article of manufacture may have hierarchical porosity (e.g., including macropores, mesopores, micropores, or a combination thereof). As an illustrative example, the article of manufacture can possess micrometer scale porosity, 20 to 40 nanometer pores between the silica nanocage core and below 10 nanometer pores inside the silica nanocage (e.g., 3 nanometer pores and 6 Å pores between the silica nanocage core).

The size of the pores (e.g., macropores) may generally decrease or increase along a dimension moving from a first surface of the article of manufacture to a second surface opposite the first surface. The gradient may be a linear gradient or a non-linear gradient, which may be controlled by either concentration of photoreactive ligands, concentration of silica nanocages or electromagnetic radiation.

The inter-particle porosity may vary. The porosity and size may be different in two or more points of the article of manufacture independently relative to the surrounding pores. In various examples, the inter-particle porosity varies within the same layer of an article of manufacture.

In an aspect, the present disclosure provides uses of articles of manufacture of the present disclosure. The articles of manufacture may be used in various applications. Non-limiting examples of uses of the articles of manufacture are provided herein.

The wide range of porosity provided by a mesoporous material of the present disclosure (e.g., an article of manufacture of the present disclosure) enables a range of separation processes relevant to, for example, separation of biomolecules (such as, for example, proteins and small molecules) for applications such as, for example, biomedical diagnostics; or separation of chemicals for other diagnostic/analytical chemistry applications.

The steps of the method described in the various examples disclosed herein are sufficient to carry out the methods of the present disclosure. Thus, in an example, the method consists essentially of a combination of the steps of the methods disclosed herein. In another example, the method consists of such steps.

The following Statements provide various embodiments of the present disclosure.

Statement 1. A composition (e.g., a photoreactive composition) (which may be referred to as an ink) comprising: a plurality of reactive components (which may be referred to individually as a monomer or a photoresponsive ligand on inorganic core (PLIC)), the individual reactive components comprising: an silica cage core, which may be mesoporous and/or microporous (e.g., as defined by IUPAC), and one or more photoreactive ligands (e.g., 1 to 1000 photoreactive ligands (e.g., 1 to 50, 1 to 100, 1 to 500, 2 to 50, 2 to 100, 2 to 500, 2 to 1000, 3 to 50, 3 to 100, 3 to 500, or 3 to 1000), including all integer number of photoreactive ligands and ranges therebetween), which may react when exposed to photons or electrons and/or provide colloidal stability to the composition, where the photoreactive ligands are bound to the silica cage core by one or more chemical bonds (e.g., covalent bond(s), coordinate covalent bond(s), ionic bond(s), hydrogen bond(s), or the like, or a combination thereof). E.g., the composition is a colloidal suspension of the reactive components. E.g., the reactive components are present at 1-70 wt. % (e.g., 40-70 or 50-70 wt. %) (based on the total weight of the composition), including all 0.1 wt. % values and ranges therebetween. E.g., a mixture of reactive components may be used. E.g., the photoreactive ligands comprise one or more chelating group and one or more photoreactive group. Non-limiting examples of chelating groups include thiol/thiolate groups, carboxylic acid/carboxylate groups, amines, silanol groups, and the like, and combinations thereof. Non-limiting examples of photoreactive groups include carbon-carbon double bonds (which may be terminal groups), acrylate groups, thiol groups, ester groups, heterocyclic groups, epoxy groups (e.g. oxiranes), isocyanate groups (e.g., diisocyanate groups), hydroxyl groups (e.g., polyols), and the like, and combinations thereof.
Statement 2. A composition (e.g., a photoreactive composition) according to Statement 1, where the photoreactive ligand(s) are chosen from acrylate ligands (e.g., acrylic acid, methacrylic acid, mono-2-(methacryloyloxy)ethyl maleate, 2-carboxyethyl acrylate, 3-sulfopropyl acrylate potassium salt, [2-(acryloyloxy)ethyl]trimethylammonium chloride solution, 2-chloroethyl acrylate, 3-chloro-2-hydroxypropyl methacrylate, 2-aminoethyl methacrylate hydrochloride, ethylene glycol methacrylate phosphate, 3-(trimethoxysilyl)propyl methacrylate, silylated acrylate, analogs thereof, which may be functionalized analogs, derivatives thereof, and the like, and combinations thereof); alkene ligands, (e.g., 2-propenoic acid, pentenoic acid, hexenoic acid, 2-methyl-4-pentenoic acid, 7-octenoic acid, allicin, allin, analogs thereof, which may be functionalized analogs, derivatives thereof, and the like, and combinations thereof); and the like, and combinations thereof.
Statement 3. A composition (e.g., a photoreactive composition) according to Statements 1 or 2 where the at least a portion of or all of the photoreactive ligands is/are functionalized (e.g., by reacting one or more of the polymerizable groups of the polymerizable ligands). E.g., one or more photoreactive ligand is functionalized with an amino acid group (such as for example, cysteine group), glutathione, biotin, nitrilotriacetic acid (NTA), iminodiacetic acid (IDA), polyadenylic acid (poly (A)), nucleotide, phospho-amino acid, boronic acids and the like, or a combination thereof. It is desirable that a functional group can perform the various known examples of protein affinity binding and purification purpose. As non-limiting illustrative examples, a Glutathione S-transferase (GST) tagged protein can specific bind to glutathione, streptavidin or avidin can bind to biotin, polyhistidine (His-) tagged proteins can specific bind to nickel NTA or nickel IDA, poly(A)-binding proteins can specific bind to the polyadenylic acid, kinases, GTPases, chaperones, motor proteins, and the like can specific bind to nucleotide, and phospho-amino acid binding proteins can specific bind to phosphor-amino acids, cis-diol groups within the oligosaccharide chains of glycoproteins can bind to boronic acids. E.g., the photoreactive ligand comprises one or more group that can react in a functionalizing reaction and the photoreactive ligand is functionalized using one or more thiol-ene reactions, Click reactions, NHS amine reactions or the like. E.g., the photoreactive ligand is functionalized with an amino acid group (such as for example, cysteine group, or the like), a protein or peptide group (such as, for example, a streptavidin group, an avidin group, or the like), a biomolecule group (such as, for example, a vitamin group (e.g., biotin group or the like), and the like, or a combination thereof. In various examples, at least a portion of or all of the photoreactive ligand(s) is/are chosen functionalized amino acid groups, glutathione groups, biotin groups, NTA groups, iminodiacetic acid groups, polyadenylic acid groups, nucleotide groups, phospho-amino acid groups, boronic acid groups, and combinations thereof.
Statement 4. A composition (e.g., a photoreactive composition) according to any one of the preceding Statements, where the composition further comprises one or more photoinitiator, which may be a free-radical photoinitiator, cationic photoinitiator, nanoparticle based photoinitiator, photo-acid generator, or a combination thereof. E.g., the photoinitiator component(s) is/are present at 1-10 wt. % (e.g., 0.1-10, 1-15%, or 1-2 wt. %) (based on the total weight of the composition). A photoinitiator may be a DOLFIN photoinitiator. In various examples, the composition further comprises one or more photoinitiator(s) chosen from free radical photoinitiators, cationic photoinitiators, nanoparticle-based photoinitiators, photo-acid generators, and combinations thereof.
Statement 5. A composition (e.g., a photoreactive composition) according to Statement 6, where the photoinitiator(s) is/are chosen from free radical photoinitiators (e.g., diphenyl(2,4,6-trimethylboenzoyl phosphine oxide), phosphine oxide, phenyl bis(2,4,6-trimethyl benzoyl), bis [2,6-difluoro-3-(1H-pyrrol-1-yl) phenyl]titanium, anthraquinone-2-sulfonic acid, 4-benzoylbiphenyl, 4,4′-bis(diethylamino) benzophenone, 2-benzyl-2-(dimethylamino)-4′-morpholinobutyrophenone, 4,4′-bis(dimethylamino) benzophenone, 4-(dimethylamino) benzophenone, 2-Hydroxy-2-methyl-1-phenyl-propan-1-one, or a combination thereof); cationic photoinitiators (e.g. diphenyliodonium hexafluorophosphate, (4-Iodophenyl)diphenylsulfonium triflate, (4-tert-Butylphenyl)diphenylsulfonium triflate, or a combination thereof); nanoparticle based photoinitiators (e.g., quantum dots, zinc oxide nanoparticles, or a combination thereof); photo-acid generators (e.g. (4-methylthiophenyl) methyl phenyl sulfonium triflate, sodium 1,2,3,4-thiatriazole-5-thiolate, tris(diphenyliodonium), 9-hydroxy-pyrene-1,4,6-trisulfonate, or a combination thereof); and combinations thereof.
Statement 6. A composition (e.g., a photoreactive composition) according to any one of the preceding Statements, where the composition further comprises one or more crosslinker(s). E.g., the crosslinker(s) is/are present at 0-60 wt. % (based on the total weight of the composition) (e.g. 0.1 to 60 wt. %), including all 0.1 wt. % values and ranges therebetween. E.g., the crosslinker(s) may comprise functional groups that react in a thio-ene reaction, a Click reaction, or the like. E.g., the crosslinker(s) is/are present at 0-60 wt. % (based on the total weight of the composition) (e.g. 0.1 to 60 wt. %), including all 0.1 wt. % values and ranges therebetween. A crosslinker may provide one or more of stability, mechanical strength, or the like, to an article of manufacture and/or provide a composition with increased reaction rate (e.g., print speed), relative to a composition with the same composition except for the crosslinker(s), in an additive manufacturing method (e.g., a method of the present disclosure).
Statement 7. A composition (e.g., a photoreactive composition) according to Statement 6, where the crosslinker(s) is/are chosen from di- to multi-thiol groups (e.g. benzene dithiol, poly(ethylene glycol) dithiol, 1,3,4-thiadiazole-2,5-dithiol, biphenyl-4,4′-dithiol), di- to multi-acrylate groups (e.g. poly(ethylene glycol) dicrylate, 1,3-butanediol diacrylate, 1,6-hexanediol diacrylate, bisphenol A ethoxylate diacrylate, ethylene glycol diacrylate, di(ethylene glycol) diacrylate, tri(ethyleneglycol) diacrylate, trimethylol propane triacrylate), and combinations thereof.
Statement 8. A composition (e.g., a photoreactive composition) according to any one of the preceding Statements, where the composition further comprises one or more oligomer(s), molecular weight from 100 to 5000 amu. E.g., the oligomer(s) is/are present at 0-90 wt. % (based on the total weight of the composition). (e.g. 0.1 to 90 wt. %), including all 0.1 wt. % values and ranges therebetween. The upper limit of an oligomer's molecular weight may depends on its chemical nature and may equal the molecular weight of a segment, at which the substance starts demonstrating one or more or all of superelastic strain, forced rubber-like elasticity, or the like, or other properties typically inherent to polymers. E.g., polar and rod-like chain oligomers have a greater range of potential molecular weight values (e.g., up to about 15,000 amu) than nonpolar oligomers (e.g., up to 5,000 amu).
Statement 9. A composition (e.g., a photoreactive composition) according to Statement 8, where the oligomer(s) is/are chosen from oligomers (e.g., oligomers having a molecular weight of 50 to 2500 g/mol) and polymers of epoxy acrylates, aliphatic urethane acrylates, aromatic urethane acrylates, ester acrylates, acrylic acrylates, and combinations thereof. An oligomer may provide one or more of stability, mechanical strength, or the like, to an article of manufacture and/or provide a composition with increased reaction rate (e.g., print speed), relative to a composition with the same composition except for the oligomer(s), in an additive manufacturing method (e.g., a method of the present disclosure).
Statement 10. A composition according to any one of the preceding Statement, where the composition further comprises a solvent. E.g., the solvent makes up the remainder of the composition.
Statement 11. A composition according to Statement 10, where the solvent(s) is/are chosen from one or more organic solvent(s) (e.g., aromatic solvents, such as, for example, benzene, toluene, xylene, and the like, aliphatic solvents, such as, for example, alkanes, cycloalkanes, and the like, polyethers or oligoethers, such as for example, propylene glycol monomethyl ether acetate, halogenated solvents, such as chloroform, dichloromethane, and the like, alcohols, such as, for example, isopropanol, butanol (e.g., n-butanol, t-butanol, isobutanol), pentanol, and the like, and the like, and combinations thereof).
Statement 12. A method (which may be an additive manufacturing method) of forming an article of manufacture, which may an article of manufacture according to any one of Statements 36-38, comprising: exposing a first layer or a selected portion of a first layer of precursor (which may be a composition of the present disclosure (e.g., a composition of any one of the preceding Statements)) to electromagnetic radiation (e.g., light, which may be provided by a laser and/or may be spatially coherent) such that a plurality of precursors react and a first layer of a material (which may be i) a polymerized material and/or ii) separated from the unreacted precursor and/or iii) continuous or discontinuous)) is formed; optionally, forming a second layer of precursor, optionally, exposing the second layer or a selected portion of the second layer of precursor to electromagnetic radiation (e.g., light, which may be provided by a laser and/or may be spatially coherent) such that a plurality of precursors in the second layer of precursor react and a second layer of a material (which may be i) a polymerized material and/or ii) separated from the unreacted precursor and/or first layer of material and/or iii) continuous or discontinuous)) is formed, and optionally, repeating the forming and exposing (e.g., the forming a layer of precursor and exposing the layer or a portion thereof to electromagnetic radiation such that a plurality of precursors react to form a layer of material as described herein) a desired number of times, where the article of manufacture (e.g., an article of manufacture comprising a plurality of layers of material) is formed. A method may include one or more processes typically used in traditional photolithographic processes (e.g., depositing/coating, patterning, development, etc.). A method may further comprise calcining the article of manufacture to remove the all or substantially all of the carbon.
Statement 13. A method according to Statement 12, where the first layer of material or all of the layers of material is/are translated relative to a surface of the precursor.
Statement 14. A method according to Statements 12 or 13, further comprising removing the first layer or all of the layers of material from the remaining (e.g., unreacted) precursor material that is unaffected by the energy.
Statement 15. A method according to any one of Statements 12-14, further comprising repeating the forming and the exposing until the entire printed structure is completed.
Statement 16. A method according to any one of Statements 12-15, where the forming and the exposing are repeated 1 to 100, 1 to 1000, 1 to 10,000, 1 to 100,000 times, or 1 to 500,000 times.
Statement 17. A method according to any one of Statements 12-16, where the forming and the exposing are repeated continuously.
Statement 18. A method according to any one of Statement 12-17, where the forming and the exposing are repeated in a batch mode.
Statement 19. A method according to any one of Statement 12-18, where the electromagnetic energy is infrared light, visible light, ultraviolet light, e-beam, or x-ray light.
Statement 20. A method according to any one of Statements 12-19, where one or more or all of the exposing is carried out using electromagnetic radiation having a wavelength of visible light (400-700 nm), Ultraviolet A (315-400 nm), Ultraviolet B (280-315 nm) and part of Ultraviolet C (190-280 nm) or e-beam. The selection of the wavelength(s) of electromagnetic radiation may be based on the particular photoinitiator(s) used.
Statement 21. A method according to any one of Statements 12-20, where one or more or all of the exposing and/or forming and exposing is/are carried out in pre-selected pattern (e.g., using a direct-write method, a lithographic method, digital light processing method, stereolithography method, or the like).
Statement 22. A method according to any one of Statement 12-21, where one or more or all the exposing and/or forming and exposing is/are carried out using a 3D printer, stereolithography, drop coating, spray coating, dip coating, inkjet printer, extrusion, electrospinning, or the like, or a combination thereof.
Statement 23. A method according to any one of Statement 12-22, where at least one or each layer of precursor and/or material has a thickness of monolayer to 10 cm (e.g., 2 nm to 500 nm, 2 nm to 2 cm).
Statement 24. A method according to any one of Statement 12-23, further comprising contacting the article of manufacture with a solvent (e.g., organic solvent, such as, toluene, propylene glycol monomethyl ether acetate, dichloromethane, acid, such as acetic acid, methacrylic acid, or a combination thereof) and/or drying (e.g., vacuum drying) the article of manufacture.
Statement 25. A method according to any one of Statements 12-24, further comprising exchanging the article of manufacture with a solvent (e.g., water, alcoholic solvent, such as, IPA, methanol, ethanol, or a combination thereof) and/or freeze-drying the solvent exchanged article of manufacture.
Statement 26. A method according to any one of Statement 12-25, further comprising drying (e.g., vacuum drying) (e.g., removing any unreacted precursor, solvent, and the like) the article of manufacture in a near critical (e.g., a supercritical) gas (e.g., near/supercritical carbon dioxide, nitrogen, or the like).
Statement 27. A method according to any one of Statement 12-26, further comprising functionalizing at least a portion of or all of the article of manufacture (e.g., by reacting one or more unreacted polymerizable ligands). E.g., one or more photoreactive ligand is reacted with a precursor (e.g., a suitably functionalized amino acid, glutathione, biotin, nitrilotriacetic acid (NTA), iminodiacetic acid (IDA), polyadenylic acid (poly (A)), nucleotide, phospho-amino acid, boronic acids etc) forming an amino acid group (such as for example, cysteine group), glutathione, biotin, nitrilotriacetic acid (NTA), iminodiacetic acid (IDA), polyadenylic acid (poly (A)), nucleotide, phospho-amino acid, boronic acids and the like, or a combination thereof. E.g., the photoreactive ligand comprises one or more group that can react in a functionalizing reaction and the photoreactive ligand is functionalized using one or more thio-ene reactions, Click reactions, NHS amine reactions or the like. E.g., the photoreactive ligand is functionalized with an amino acid group (such as for example, cysteine group, or the like), a protein or peptide group (such as, for example, a streptavidin group, an avidin group, or the like), a biomolecule group (such as, for example, a vitamin group (e.g., biotin group or the like), and the like, or a combination thereof.
Statement 28. A method according to any one of Statements 12-27, where the article of manufacture is in the form of (e.g., has a macroscopic shape of) a monolithic structure, a free-standing film, or a film disposed on at least a portion of or all of a substrate, a structure anchored in confined environment such as, tubes or channels (e.g., of a microfluidic device).
Statement 29. A method according to any one of Statements 12-28, where the article of manufacture is porous (e.g., microporous (e.g., having pores with a size (e.g., at least one dimension) of 0.1-2 nm), mesoporous (e.g., having pores with a size (e.g., at least one dimension) of 2-50 (e.g., 20-50 nm)), macroporous, or a combination thereof) (e.g., comprises intra-particle (silica nanocage core) micropores and/or mesopores) and/or inter-particle (silica nanocage core) macropores), where at least a portion or all of the pores may be interconnected. E.g., the article of manufacture comprises a network of polymerized reactive components. E.g., at least a portion or all of the article of manufacture has a microporous network, a mesoporous network, a macroporous network, or a combination thereof. An article of manufacture may have a desirable distribution (e.g., relative ratio) of pore sizes (e.g., micropores, mesopores, macropores, or a combination thereof), which may be based on total pore volume of, if present, micropores and/or mesopores and/or macropores.
Statement 30. A method according to any one of Statements 12-29, where the article of manufacture comprises macropores having at least one dimension (e.g., a height) as measured in a plane perpendicular to an axis of the pore) of 500 microns to 1 micron (e.g., 200 microns to 1 micron or 100 microns to 1 micron), and/or at least a portion of or all of the silica nanocage cores are microporous and/or mesoporous (e.g., microporous and/or mesoporous as defined by IUPAC).
Statement 31. A method according to any one of Statements 12-30, where the article of manufacture has hierarchical porosity (e.g., including macropores, mesopores, micropores, or a combination thereof). As an illustrative example, the article of manufacture can possess micrometer scale porosity, 20 nanometer pores, 3 nanometer pores and 6 A pores between the silica nanocage core.
Statement 32. A method according to any one of Statements 12-31, where the article of manufacture has a hierarchical pore gradient. The size of the pores (e.g., macropores) generally decrease or increase along a dimension moving from a first surface of the article of manufacture to a second surface opposite the first surface. The gradient may be a linear gradient or a non-linear gradient.
Statement 33. A method according to any one of Statements 12-32, where all of the layers are formed using the same composition and/or the same processing conditions (e.g., electromagnetic energy intensity, electromagnetic energy wavelength, total electromagnetic energy, layer thickness, pattern (if used), print speed (if used), or the like, or a combination thereof).
Statements 34. A method according to any one of Statements 12-33, where at least one, at least two, at least five, at least ten, at least 20, at least 50, the majority of, or all of the layers (or a portion thereof) are formed using a different composition and/or different processing conditions (at least one of silica nanocage core, photolithographic ligand, solvent, or the like, or a combination thereof and/or at least one process parameter (e.g., electromagnetic energy intensity, electromagnetic energy wavelength, total electromagnetic energy, layer thickness, pattern (if used), print speed (if used), or the like, or a combination thereof) is different for one or more or all of the layers (e.g., different for one or more or all of the individual exposing or exposing and forming).
Statement 35. A method according to any one of Statements 12-34, where the article of manufacture is not annealed (e.g., annealed post-formation).
Statement 36. A method according to any one of Statements 12-35, where a first porous article of manufacture is formed and the method is repeated such that a second article of manufacture is formed within the first porous article of manufacture.
Statement 37. A three-dimensional (3D) article of manufacture, which may be a three-dimensional (3D) printed article of manufacture, (which may be made using a composition of the present disclosure (e.g., a composition of any one of Statements 1-11) or by a method of the present disclosure (e.g., a method of any one of Statements 12-36)).
Statement 38. A three-dimensional (3D) article of manufacture, which may be a three-dimensional (3D) printed article of manufacture, according to Statement 37, where the article of manufacture is in the form of a monolithic structure, a free-standing film, or a film disposed on at least a portion of or all of a substrate (e.g., a glass substrate).
Statement 39. A three-dimensional (3D) article of manufacture, which may be a three-dimensional (3D) printed article of manufacture, according to Statements 37 or 38, where the article of manufacture is porous (e.g., microporous (e.g., having pores with a size (e.g., at least one dimension) of 0.1-2 nm), mesoporous (e.g., having pores with a size (e.g., at least one dimension) of 20-50 nm), macroporous, or a combination thereof) (e.g., comprises intra-particle (silica nanocage core) micropores and/or mesopores) and/or inter-particle (silica nanocage core) macropores), where at least a portion or all of the pores may be interconnected. E.g., the article of manufacture comprises a network of polymerized reactive components. E.g., at least a portion or all of the article of manufacture has a microporous network, a mesoporous network, a macroporous network, or a combination thereof. An article of manufacture may have a desirable distribution (e.g., relative ratio) of pore sizes (e.g., micropores, mesopores, macropores, or a combination thereof), which may be based on total pore volume of, if present, micropores and/or mesopores and/or macropores, if present.
Statement 40. A three-dimensional (3D) article of manufacture, which may be a three-dimensional (3D) printed article of manufacture, according to any one of Statements 37-39, where the article of manufacture comprises macropores having at least one dimension (e.g., a height) as measured in a plane perpendicular to an axis of the pore) of 500 microns to 1 micron (e.g., 200 microns to 1 micron or 100 microns to 1 micron), and/or at least a portion of or all of the silica nanocage cores are microporous and/or mesoporous (e.g., microporous and/or mesoporous as defined by IUPAC).
Statement 41. A three-dimensional (3D) article of manufacture, which may be a three-dimensional (3D) printed article of manufacture, according to any one of Statements 37-40, where the article of manufacture has hierarchical porosity.
Statement 42. A three-dimensional (3D) article of manufacture, which may be a three-dimensional (3D) printed article of manufacture, according to any one of Statements 37-41, where the article of manufacture has a hierarchical pore gradient. The size of the pores (e.g., macropores) generally decrease or increase along a dimension moving from a first surface of the article of manufacture to a second surface opposite the first surface. The gradient may be a linear gradient. The article of manufacture may comprise mesopores and/or macropores. The mesopores may be mesopores as defined by IUPAC.
Statement 43. A three-dimensional (3D) article of manufacture, which may be a three-dimensional (3D) printed article of manufacture, according to any one of Statements 37-42, where the article of manufacture has a constant composition.
Statement 44. A three-dimensional (3D) article of manufacture, which may be a three-dimensional (3D) printed article of manufacture, according to any one of Statements 37-43, where at least a portion of (e.g., at least one, at least two, at least five, at least ten, at least 20, or at least 50 regions of, which may be individual layers as described herein) or the majority of the article of manufacture has a different composition.
Statement 45. A three-dimensional (3D) article of manufacture, which may be a three-dimensional (3D) printed article of manufacture, according to any one of Statements 37-44, where the article of manufacture is not annealed.
Statement 46. A three-dimensional (3D) article of manufacture, which may be a three-dimensional (3D) printed article of manufacture, according to any one of Statements 37-45, where the article of manufacture is a part of a microfluidic device, an HPLC column, a fluidic channel, a point of care device, a diagnostics device, or the like.
Statement 47. A three-dimensional (3D) article of manufacture, which may be a three-dimensional (3D) printed article of manufacture, according to any one of Statements 37-46, where the article of manufacture exhibits one or more or all of the following: porosity (e.g., hierarchical porosity), one or more desirable mechanical properties (e.g., modulus), or the like.
Statement 48. Use of a three-dimensional (3D) printed of manufacture of the present disclosure, which may be a three-dimensional (3D) printed article of manufacture, (which may be made using a composition of the present disclosure (e.g., a composition of any one of Statements 1-11) or by a method of the present disclosure (e.g., a method of any one of Statements 12-36 or a three-dimensional (3D) printed article of manufacture according to any one of Statements 37-47) in a separation method (e.g., a biomolecule separation), which may be based on size exclusion, affinity, charge, or the like, an analytical method, a drug delivery method, a sensing method, which may be a biosensing method, a catalytic method, which may be a biocatalytic method, or the like.

The following examples are presented to illustrate the present disclosure. The examples are not intended to be limiting in any matter.

### Example 1

The following example provides a description of compositions of the present disclosure.

Herein, ultrasmall silica nanocages were combined with digital light processing technique for the direct 3D printing of hierarchically porous parts with arbitrary shapes, tunable internal structures and high porosity. It was demonstrated how this approach can be applied for the implementation and deliberate positioning of various functionalities throughout 3D printed objects. Furthermore, the mesoporous materials enable internal 3D printing approaches to complex 3D material designs not accessible otherwise. Without it being bound by any particular theory, it is expected this approach will open up unexplored avenues to advanced materials and devices.

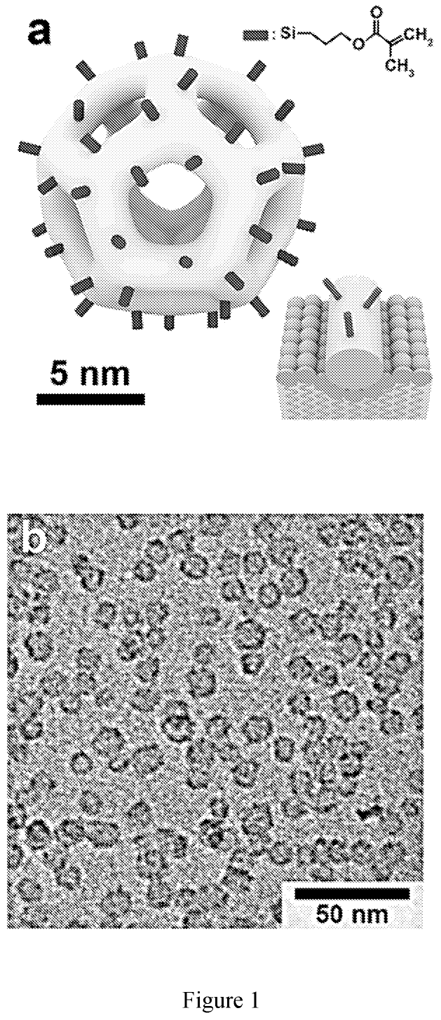

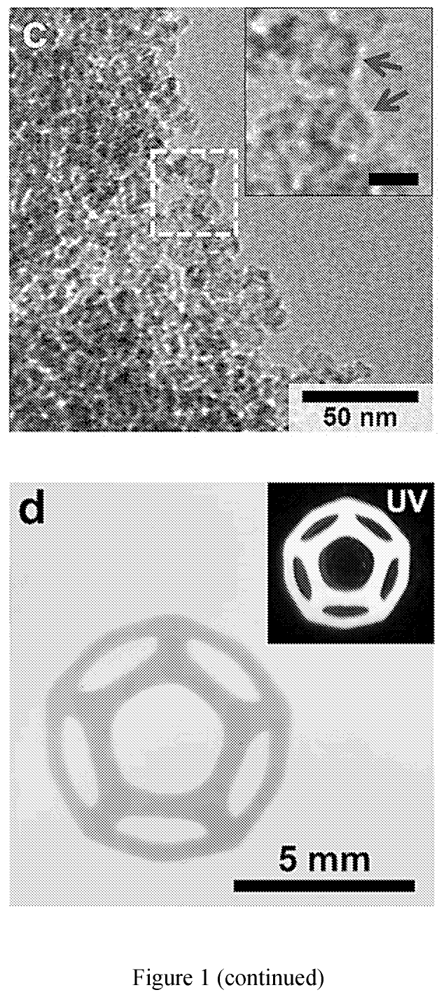

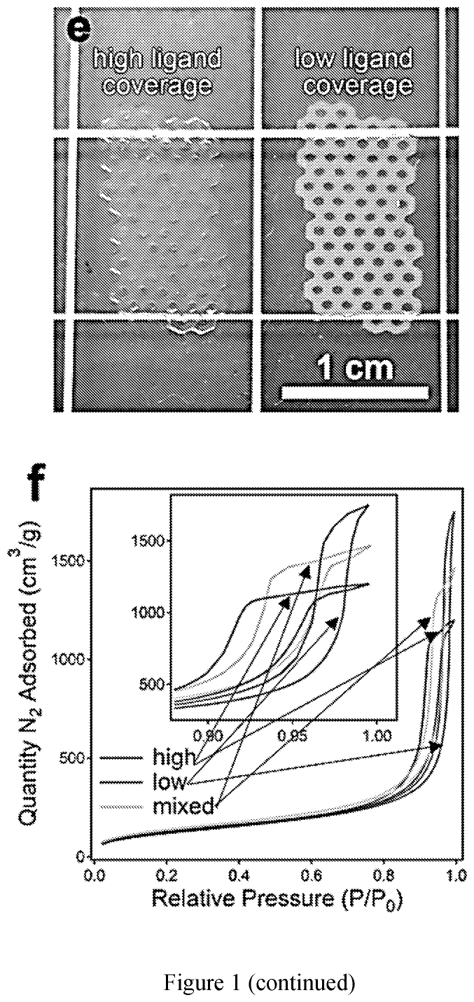

Ultrasmall (about 10 nm) silica cages formed around cetyltrimethylammonium bromide (CTAB) micelles swollen with mesitylene and exhibiting well-defined pentagonal dodecahedral symmetry with a single roughly 7 nm diameter internal spherical pore and 4 nm wide openings on each face (FIG. 1a) were used. Their sol-gel synthesis is based on hydrolysis and condensation of tetramethyl orthosilicate (TMOS) as the silane precursor provides a versatile platform for their subsequent surface functionalization with a large variety of commercially available organosilanes. These cages constitute the elementary units forming a number of periodic mesoporous silica materials. Despite substantial fundamental and technological interest, few examples exist of 3D printed mesoporous materials. Most examples are limited to extrusion techniques, often with the need for a calcination step to remove the template and generate porosity. Ultrasmall photoresponsive ligand stabilized silica cages provide an opportunity to formulate innovative PLIC inks for the assembly of predesigned macroscopic functional porous objects by means of DLP 3D printing. This approach enables the direct printing of mesoporous parts with high pore accessibility and control over the internal structure.

Silica cages were functionalized with methacrylate bearing silane groups to allow their use as photoresponsive building blocks in the 3D printer (FIG. 1). To that end, 3-(trimethoxysilyl)propyl methacrylate was added directly to the solution after cage synthesis, but with the structure directing surfactant micelles still present. Previous studies suggested that as part of their formation mechanism, the cage vertices and struts deform the micelle surface, with positively charged surfactant molecules wrapping the negatively charged inner silica cage surface. As illustrated in the inset of FIG. 1a, this soft-templating approach allows to distinguish between inner and outer cage surfaces, forcing the methacrylate bearing silane groups to attach predominantly on the outer surface. Subsequent surfactant micelle removal by dialysis in an acidic water/ethanol mixture caused the cages to precipitate, consistent with efficient cage modification with hydrophobic methacrylate groups. This is further supported by the colloidal stability of the cages after washing with ethanol and transfer into non-polar solvents such as toluene. The original silica cage synthesis was scaled up by a factor of 30 to enable the 3D printing of large parts. The TEM image in FIG. 1b shows that cages from the large scale synthesis have similar structures as observed in the initial discovery. To formulate the photoresponsive ink for the 3D printer, we combined the methacrylate functionalized cages with diphenyl(2,4,6-trimethylbenzoyl) phosphine oxide (TPO) as the photoinitiator. Exposing this formulation to light using a DLP UV projector (385 nm, 1.2 J/cm²) locally triggers the polymerization of the methacrylate groups and forms robust connections between constituent silica cage building blocks, creating a mesoporous monolith with programmable geometry.

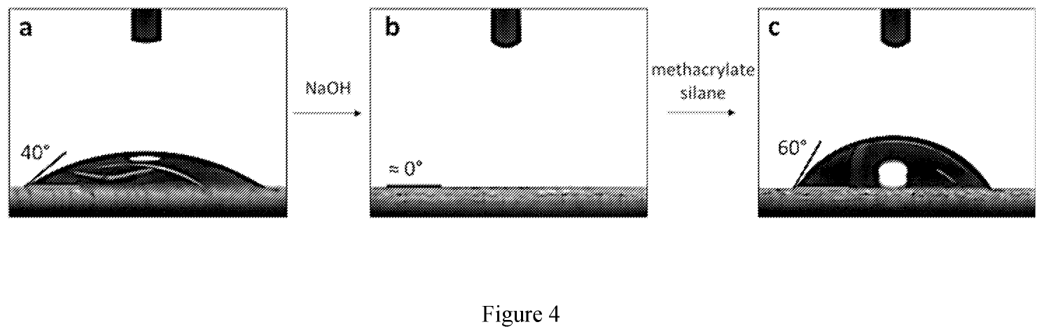

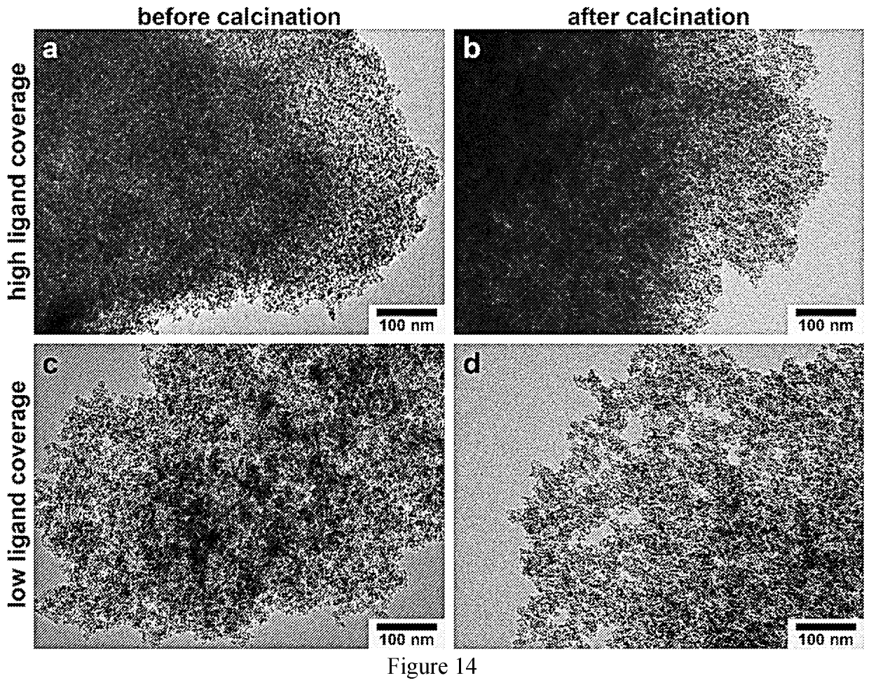

Macroscopic patterns were printed on glass slides using the PLIC ink as illustrated in FIG. 1d. To improve adhesion of the printed parts, glass substrates were functionalized with methacrylate groups prior to printing. The glass slides were first treated with a strong base to increase the surface density of silanol groups, and promote subsequent condensation with methacrylate-silane. This process was monitored by contact angle measurements (FIG. 4). An increase in the hydrophobicity of the substrate confirmed grafting with methacrylate groups. The projection of a dodecahedron was patterned on such a substrate (FIG. 1d), demonstrating the large scale and shape control capabilities offered by this technique. Silica cages were labelled with an organic dye during the synthesis for ease of visualization, which also made the pattern fluorescent under UV illumination (inset FIG. 1d). TEM analyses of pieces of the printed part (FIG. 1c and FIG. 14) evidenced the porous character of the macroscopic structure. A closer look at the edge of such a piece further confirmed that the cage structure was preserved during the printing process (inset FIG. 1c). This method therefore enables the rapid deposition or 3D printing of porous materials with user-defined shape. Here, parts were printed from a single projection layer, typically resulting in a thickness of about 1 mm (FIG. 5), with lateral dimensions in the centimeter range (FIG. 1d, e).

Large and free-standing honeycomb structures printed with different methacrylate ligand coverage of the cages are illustrated by the examples in FIG. 1e. Adjusting the ligand coverage allowed control of the printed materials density. Comparison of parts fabricated from low and high ligand coverage PLICs revealed a positive correlation between methacrylate-silane ratio and density, with the low coverage part being 1.7 times lighter than the high coverage one (see detailed geometry analysis in the FIG. 5). The difference in density is attributed to varying internal microstructures. These parts had similar specific surface areas, specifically 438 m² g⁻¹ and 450 m² g⁻¹ for the high and low coverage parts, respectively, as determined by the Brunauer-Emmett-Teller (BET) method. The hysteresis of the nitrogen sorption measurements (FIG. 1f) show important differences in adsorption-desorption behavior. The broader hysteresis of the high coverage part suggests that access to mesopores is more restricted than in the case of the low coverage part, for which mesopore access is facilitated by the presence of interstitial space and channels.

The optical properties of the printed structure are also sensitive to the methacrylate-silane ratio of the PLIC ink as illustrated by the photographs in FIG. 1e. While the high coverage part appears relatively transparent, the low coverage one is more translucent due to light scattering by larger pores. To induce significant Mie scattering, these larger pores likely are a few tens of nanometers in size and correspond to interparticle pores because the intraparticle pores, i.e., cores of the cages, are less than 10 nm. Since the parts have similar specific surface area regardless of the ligand coverage, these large interparticle pores do not contribute significantly to the total surface area. Instead, the high specific surface areas mostly derive from the intraparticle pores of the cage structure and from the microporosity of silica itself. Varying the ligand coverage of cage-based PLIC inks therefore is a tool to purposefully tune the porosity and internal structure of 3D printed objects. As a validation and reproducibility check, a PLIC ink was prepared by mixing the two cage samples in equivalent proportions. The isotherms of the resulting printed part, denoted as ‘mixed’ (FIG. 1f), showed an intermediate behavior between those obtained from the parent high or low coverage materials, hence offering an additional knob to tune the microstructure of these macroscopic objects.

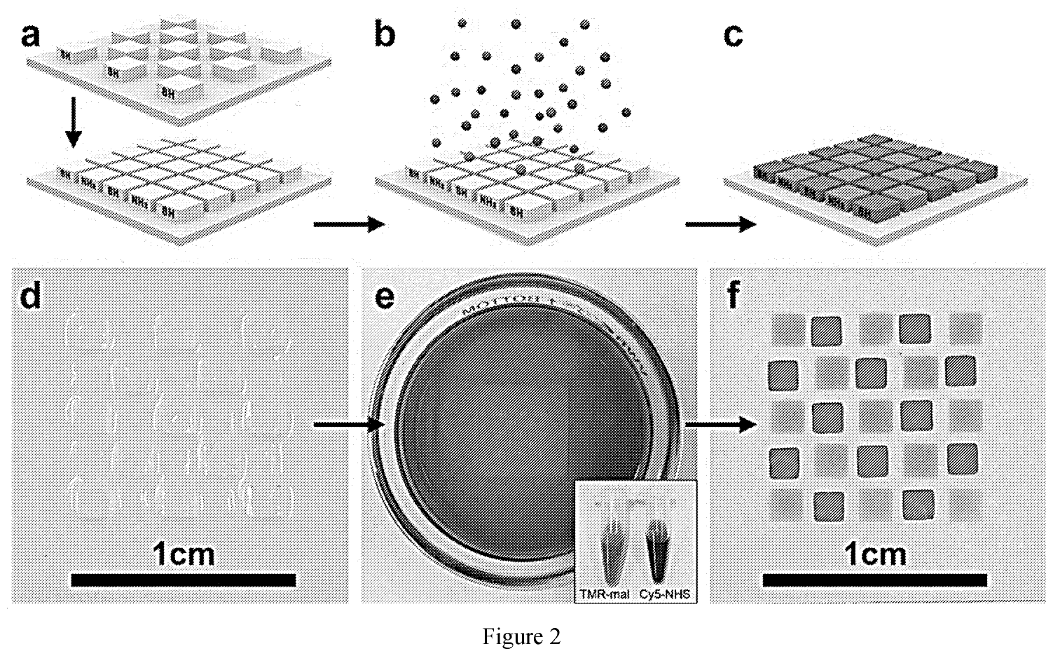

The ability to directly print 3D shapes of porous materials with controlled structure, complemented by the large choice in possible cage surface functional groups, offers a versatile platform to realize advanced materials with innovative designs. Specific functionalities can thereafter be implemented with high spatial control in complex 3D architectures. As a proof-of-concept experiment (FIG. 2), methacrylate functionalized cages were modified post-synthesis, but prior to printing, with either thiol or amine groups, using (3-mercaptopropyl)trimethoxy-silane (MTPMS) or (3-aminopropyl)trimethoxy-silane (APTMS), respectively. Two successive layers were printed on a modified glass substrate, to create a checkerboard pattern with spatially resolved thiol and amine functionalized tiles (FIG. 2a,d). To demonstrate the spatially programmable chemical functionality of these materials, the structure was immersed for 1 hour under gentle shaking (about 50 rpm) in 5 mL of a mixture of 200 nmol of tetramethylrhodamine-6 C2 maleimide (TMR-mal, pink dye in FIG. 2b,e) and 200 nmol of sulfo-cyanine5 succinimidyl ester (Cy5-NHS, blue dye in FIG. 2b,e) in DMSO. Thanks to the porous nature of the printed material, these two dyes penetrated the structure and selectively bound to specific tiles based on their respective click chemistry (FIG. 2c,f). This result is in line with nitrogen sorption results suggesting high pore accessibility and demonstrates that larger molecules such as organic dyes can infiltrate the as-printed structures. It is noted that this approach can be extended to biological applications, such as bioassays, for the detection of specific peptides or proteins for instance, where selectivity can be addressed as a function of chemical functionality as well as controlled porosity for size exclusion strategies. Since the porous particles are ultrasmall, and their inner and outer surfaces can be orthogonally functionalized prior to printing, this provides access to high information density materials, e.g., for multiplexed detection of various analytes and substrates.

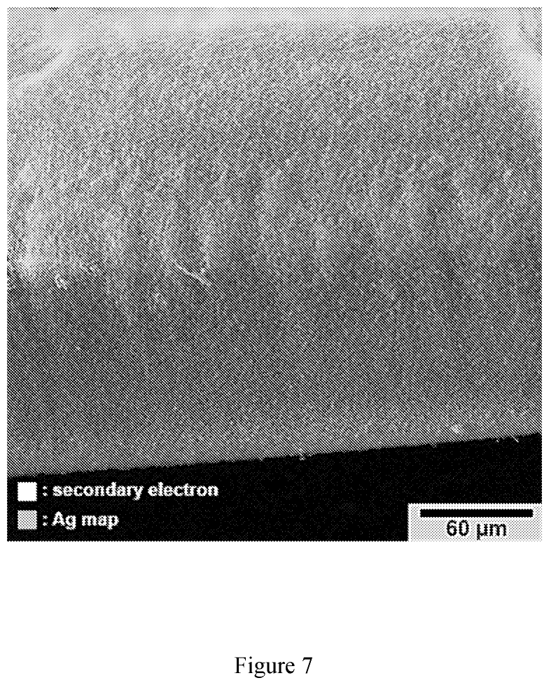

Making use of the printed cage-based mesoporous materials, we developed a hitherto unknown internal 3D printing approach. Here, the porosity of an already printed 3D part serves as a scaffold for the subsequent printing of a second 3D material directly within the first. To demonstrate this concept, a second metal structure was printed within the pores of the first silica structure. As illustrated in FIG. 3, a 3D block of silica cages was first printed as described before and then soaked for 30 minutes in a solution of silver nitrate (0.1 M in 10:1 v/v ethanol:toluene), and two photoinitiators, namely TPO (0.05 M) and Darocur 1173 (0.5 M). In this case, TPO acts as a sensitizer for Darocur 1173, which serves as the electron donor for the reduction of Ag⁺ to Ag⁰. A light pattern was then projected in the form of three slabs to locally reduce silver, which remained embedded in the original 3D silica block (FIG. 3d-f). The analysis of the cross-section by energy dispersive X-ray spectroscopy (EDS) confirmed the presence of silver inside the structure (FIG. 7). The 3D printing of a second material within a 3D printed mesoporous silica block opens a broad and versatile opportunity space. Through this approach, the two materials are entangled with each other, which means that the structure of the scaffold or host material will influence the structure and therefore properties of the guest material. This entanglement also allows for interactions, such as charge transport, between the two materials. These interactions may even benefit from the high interfacial area between them. Deliberately varying the porosity of the silica host and hence the interconnectivity of the guest materials, thereafter modulates charge and ion transport properties throughout the printed structure. Filling the cages with electrochemically active guest materials further creates an interesting new class of ‘confined but connected’ materials with important practical implications, e.g., for the design and discovery of battery materials with programmable mesostrucure and hierarchical architectures. This approach can readily be extended to a large variety of materials (e.g., semiconductors and metal oxides) offering a wealth of unique properties. For instance, printing two different catalytic materials within a porous scaffold could result in a highly tunable platform with controlled symmetry and flux for tandem catalysis applications. The whole 3D printing toolbox can thereafter be put to practice for the internal printing and positioning of active centers within the host scaffold with a great degree of freedom.

In conclusion, the design of PLIC inks based on functional nanomaterials, and their combination with 3D printing techniques, such as DLP, offers an innovative playground to engineer ever more sophisticated devices with increased capabilities. By using intrinsically porous nano-sized building blocks, a technique was developed for the direct printing of mesoporous parts, which in turn enabled a hitherto unknown internal 3D printing approach. The versatile functionalization of the silica cages further allowed to control the internal microstructure and functionalities of the printed structures. Without out being bound by any particular theory, it is considered this approach will enable a number of novel device architectures with important potential for sensing, catalytic, or energy applications, which so far were not directly accessible with conventional material processing techniques.

Methods.

Methacrylate functionalized silica cages: Silica cage synthesis was adapted from a previously reported method. In a 500 mL flask, 3.75 g of CTAB was dissolved in 300 mL of water at 30° C. 300 μl of ammonia (2 M in ethanol) and 3 mL of mesitylene were added and the mixture was allowed to stir (800 rpm) for 4 hours. 3 mL of TMOS was then added slowly and the reaction was left to proceed for one day at 30° C. For initial experiments (samples denoted as high ligand coverage materials), 3 mL of 3-(trimethoxysilyl)propyl methacrylate (methacrylate-silane) was added slowly and the reaction was left to proceed for another day. For samples denoted as low ligand coverage materials, only 1.2 mL of methacrylate-silane was added. For purification of the functionalized cages, the synthesis solution was first dialyzed in 2 L of water:ethanol:acetic acid (v/v 500:500:7) under slow stirring, changing the solution 4 times over the course of 2 days, then dialyzed in 2 L of water, changing the solution 3 times over the course of 4 days. The cages were then collected by centrifugation (7000 g, 10 min) and redispersed in 150 mL of ethanol. The cages were further washed using spin filters (VivaSpin, 100 kDa MWCO) and centrifugation (2400 g), until concentrated to a total volume of 4.5 mL. The cage solution was finally diluted with 4.5 mL of toluene and used as made.

In-situ dye functionalization of cages: For the direct fluorescent labeling of cages during the synthesis (FIG. 1d), the synthesis was downscaled 15 times. A dye-silane conjugate was prepared one day prior to the synthesis by mixing 0.45 μmol of TMR-mal and 1.74 μL of MPTMS in 67 μL of dimethyl sulfoxide (DMSO) under inert atmosphere. This dye-silane conjugate was added immediately after the TMOS addition during the cage synthesis. The remainder of the procedure was kept unchanged.

Thiol and amine functionalization: For the post-synthesis modification of cages, either 83.2 μL of MTPMS or 78.4 μL of APTMS (for thiol and amine functionalization, respectively) was added to 4 mL of the cage solution. The mixture was allowed to stir for 3 days at room temperature and then used as is.

Modification of glass substrates: For the preparation of methacrylate functionalized substrates, cover glass slides (1.8×1.8 cm) were first activated by soaking overnight in a petri dish containing 5 mL of a 0.2 M NaOH solution in water. The substrates were then rinsed with water and soaked another night in a mixture of 3.5 ml ethanol, 0.5 mL NH₄OH (28-30% in water) and 1 mL of methacrylate-silane. The substrates were finally rinsed with ethanol and dried with nitrogen.

3D printing: PLIC inks for printing were formulated by dissolving the photoinitiator, diphenyl(2,4,6-trimethylbenzoyl) phosphine oxide (7 mM), in the silica cage solutions. The inks were bubbled with nitrogen for 2 minutes before usage to remove oxygen. Samples were printed with a homemade top-down digital light processing (DLP) 3D printer operating with 385 nm wavelength light and intensities of about 10 mW/cm². For printing on modified glass substrates, substrates were placed on top of a fitted piece of Si wafer in a 1.9×1.9 cm square shaped Teflon dish. 280 μL of the ink was added to the dish and the part was printed as a single layer by projecting the light pattern for 2 minutes. For the printing of freestanding parts (FIG. 1e), the samples were printed directly on top of the Si wafer, resulting in easy detachment after drying. Printed samples were washed with methanol for 24 hours and dried with supercritical carbon dioxide dryer (Leica CPD300).

Characterization methods: TEM images were acquired using a FEI Tecnai T12 Spirit microscope operated at an acceleration voltage of 120 kV. SEM and EDS images were acquired using a Tescan Mira3 field emission SEM. Nitrogen sorption isotherms were acquired using a Micromeritics ASAP 2020. Confocal microscopy images for dimension analyses were acquired using a Keyence VK-X260 laser-scanning confocal microscope.

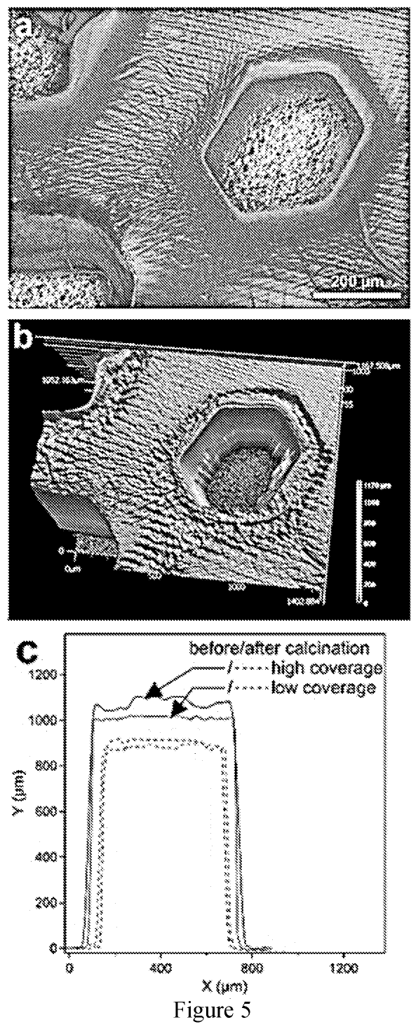

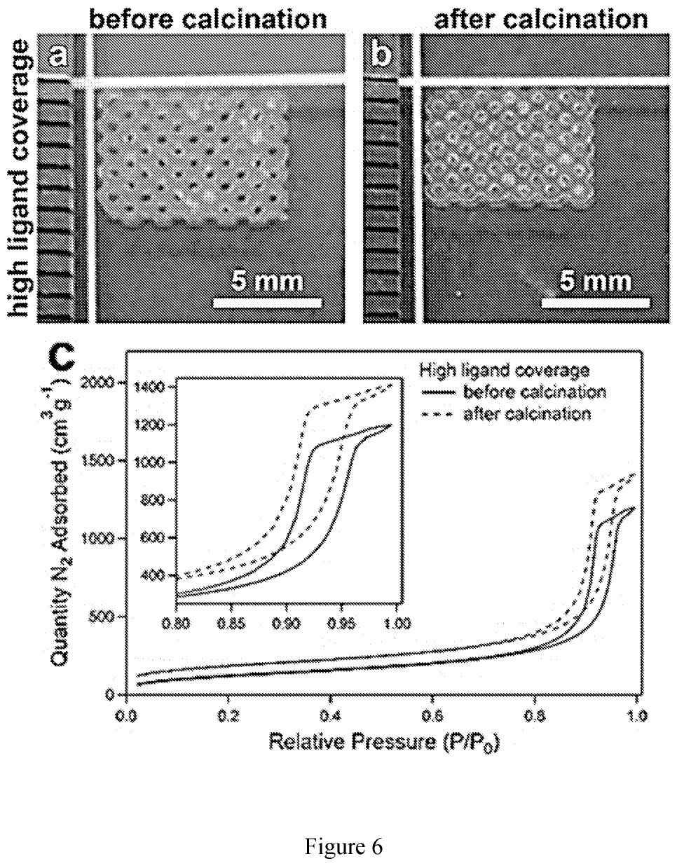

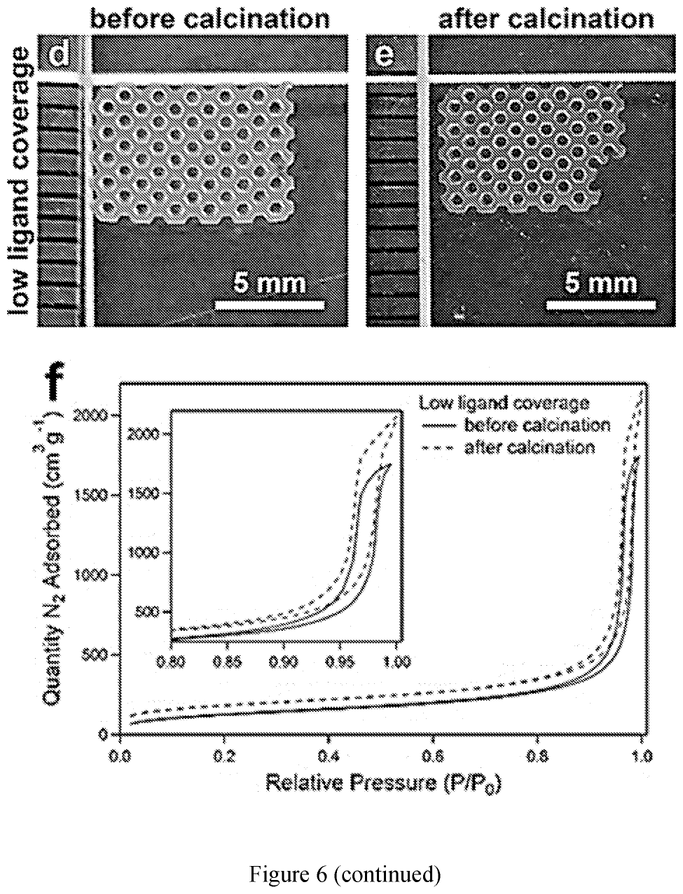

If desired, the organic components of the printed parts can be removed by calcining the structures (550° C. for 6 hours in air) to produce fully inorganic parts while preserving their macrostructure as well as their microstructure (FIG. 6). Calcination of the printed parts with high and low coverage resulted in an isotropic shrinkage of 17% and 12%, respectively (FIG. 5), together with a weight loss of 29% and 18%, respectively. These differences in shrinkage and weight loss are consistent with the different ratio of organic to inorganic components between the high and low coverage samples. Nitrogen sorption measurements before and after calcination showed very similar hysteresis shapes, suggesting that microstructure and mesopore access remained unchanged (FIG. 6). In addition, the specific surface area increased to 646 m² g⁻¹ and 639 m² g⁻¹ for the high and low coverage materials, respectively (as compared to 438 m² g⁻¹ and 450 m² g⁻¹ before calcination).

### Example 2

The following example provides examples of nanoparticles of the present disclosure and uses thereof.

Herein, ultrasmall (about 10 nm) silica nanocages are combined with digital light processing technique for the direct 3D printing of hierarchically porous parts with arbitrary shapes, as well as tunable internal structures and high surface area. Due to the versatile and orthogonal cage surface modifications, it was shown that these materials can be applied for the implementation and positioning of functionalities throughout 3D printed objects. Furthermore, taking advantage of the internal porosity of the printed parts, an internal printing approach is proposed for the localized deposition of a guest material within a host matrix, enabling complex 3D material designs.

To fully exploit the potential of the combination of nanomaterials and 3D printing techniques, a class of functional inks based on a photoresponsive ligand on inorganic core (PLIC) design were developed. This approach leverages prior nanomaterials research with its development of a large variety of nanosized building blocks offering a wide range of properties. Advances in surface chemistry of nanostructured materials have enabled their functionalization with tailored surface ligands. The confluence of nanomaterials synthesis and advanced additive manufacturing methods now allows materials scientists and engineers to combine nanoscale properties of matter with the micro- and macroscale structural control offered by 3D printing techniques.

Results.

Formulation of the cage-based PLIC ink. Ultrasmall (about 10 nm) silica cages formed around cetyltrimethylammonium bromide (CTAB) micelles swollen with mesitylene and exhibiting well-defined pentagonal dodecahedral symmetry with a single roughly 7 nm diameter internal spherical pore and 4 nm wide window openings on each face were used (FIG. 1a). Their sol-gel synthesis based on hydrolysis and condensation of tetramethyl orthosilicate (TMOS) as the silane precursor provides a versatile platform for their subsequent surface functionalization with a large variety of commercially available organosilanes. These cages constitute the elementary units forming a number of 2D and 3D mesoporous silica materials. Despite substantial fundamental and technological interest, few examples exist of 3D printed mesoporous materials. It is believed there are no examples resulting from the use of inks derived from individual porous cage structures formulated as inks. Most examples of 3D printed mesoporous materials are limited to extrusion techniques, often with the need for a calcination step to remove the template and generate porosity. Ultrasmall photoresponsive ligand stabilized porous cages provide an opportunity to formulate innovative PLIC inks for the direct assembly of predesigned macroscopic functional porous objects by means of DLP 3D printing. This approach enables the direct printing of mesoporous parts with high pore accessibility and control over the internal structure.

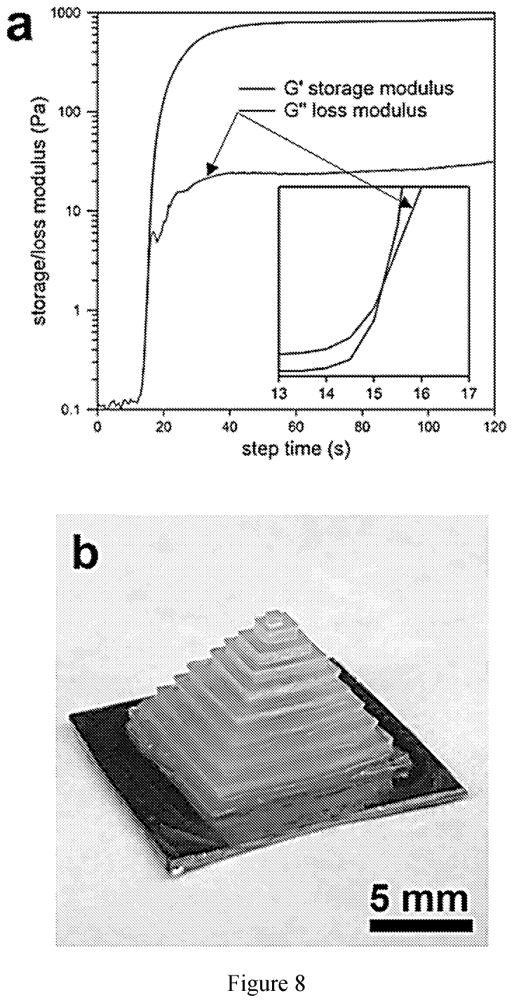

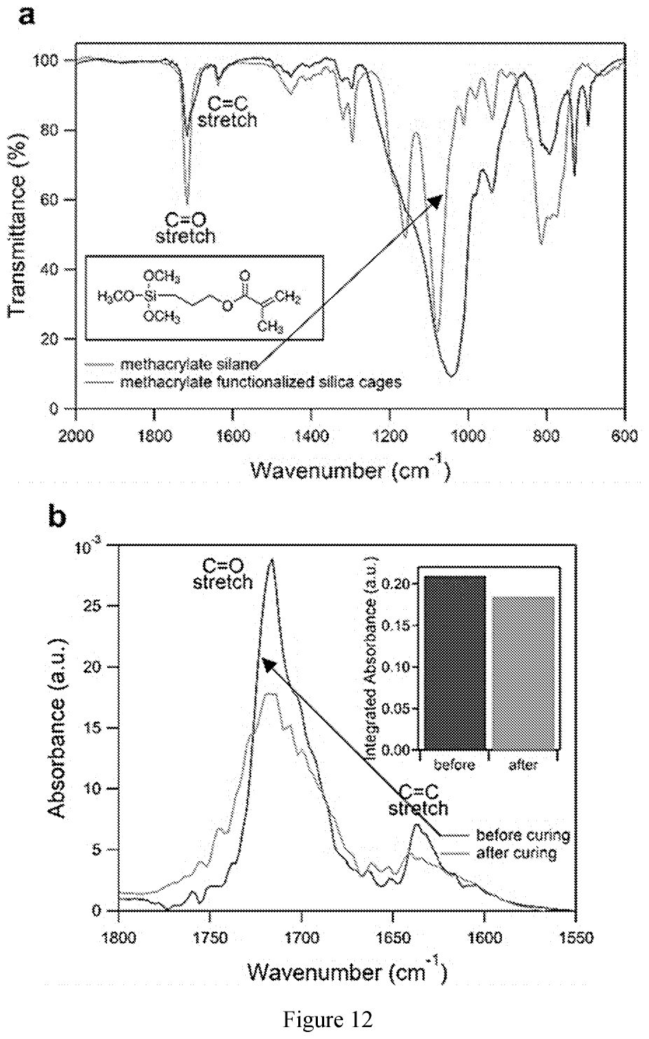

Silica cages were functionalized with methacrylate bearing silane groups to allow their use as photoresponsive building blocks in the 3D printer (FIGS. 1 and 8). 3-(trimethoxysilyl)propyl methacrylate was added directly to the solution after cage synthesis, but with the structure directing surfactant micelles still present. Previous studies suggested that as part of their formation mechanism, the cage vertices and struts deform the micelle surface, with positively charged surfactant molecules wrapping the negatively charged inner silica cage surface. As illustrated in the inset of FIG. 1a, this soft-templating approach allows to distinguish between inner and outer cage surfaces, forcing the methacrylate bearing silane groups to attach predominantly on the outer surface. The cages were subsequently purified by dialysis in an acidic water/ethanol mixture, which was shown to efficiently etch away the surfactant template. Removing the cationic surfactant micelle caused the cages to precipitate, consistent with efficient cage modification with hydrophobic methacrylate groups. This is further supported by the colloidal stability of the cages after additional washing with ethanol and transfer into non-polar solvents such as toluene. The methacrylate functionalization was also evidenced by Fourier-transform infrared spectroscopy (FTIR) analyses of the ink, showing the characteristic absorption bands of methyl methacrylate groups (FIG. 12). The original silica cage synthesis was scaled by a factor of 30 (from 10 mL to 300 mL) to enable the 3D printing of large parts. Transmission electron microscopy (TEM) studies (see cage image in FIG. 1b from a 300 mL batch) did not show any noticeable change in cage structure from comparisons with smaller batch size derived materials. This was encouraging and may suggest that the relatively facile water-based synthesis may be further scaled up. To formulate the photoresponsive ink for the 3D printer, the methacrylate functionalized cages were combined with diphenyl(2,4,6-trimethylbenzoyl) phosphine oxide (TPO) as the photoinitiator. Exposing this formulation to light using a DLP UV projector (385 nm, 10 mW cm′) locally triggers the polymerization of the methacrylate groups and forms robust connections between constituent silica cage building blocks, creating a mesoporous monolith with programmable geometry. The cross-linking of methacrylate groups is supported by FTIR measurements before and after light exposure (FIG. 12), which suggested a decrease in the alkene signal as compared to the carbonyl signal.

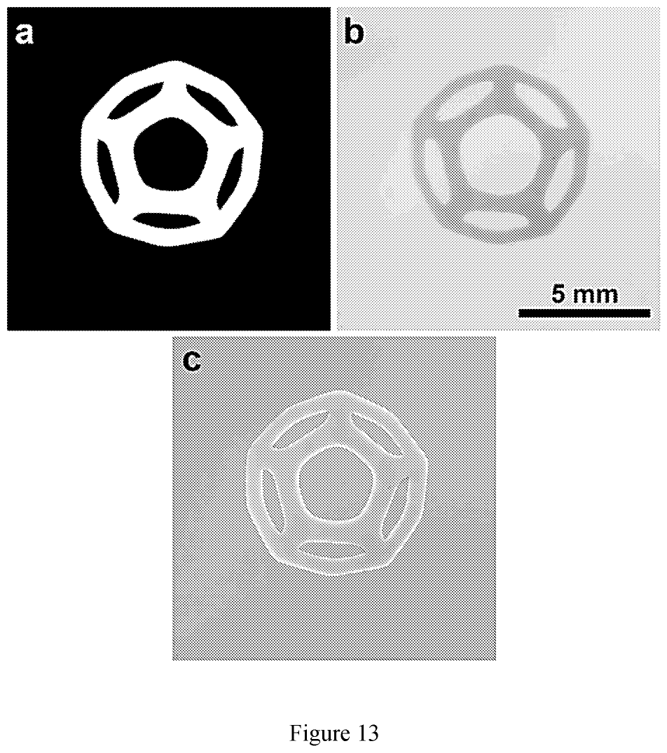

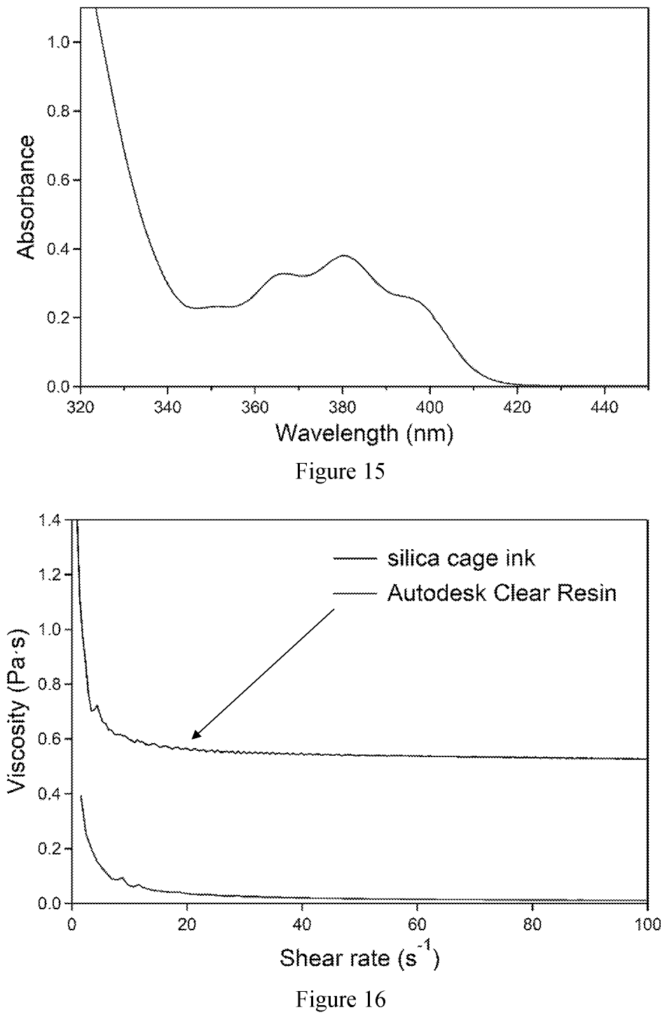

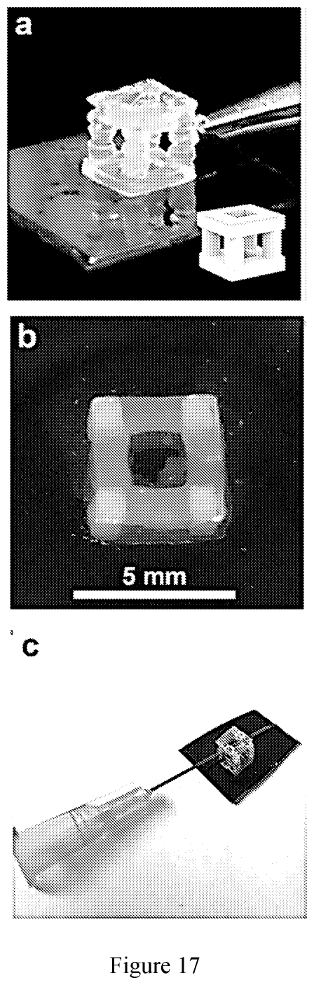

Direct 3D printing of mesoporous parts. Macroscopic patterns were printed on glass slides using the PLIC ink as illustrated in FIG. 1d (2 min exposure, light dose 1.2 J cm′). We patterned the projection of a dodecahedron (FIG. 1d), demonstrating the large scale and shape control capabilities offered by this technique. The printed part showed high fidelity to the projection pattern (FIG. 13). Silica cages were labelled with an organic dye during the synthesis for ease of visualization, which also made the pattern fluorescent under UV illumination (inset FIG. 1d). TEM analyses of pieces of the printed part (FIG. 1c and FIG. 14) evidenced the porous character of the macroscopic structure. A closer look at the edge of such a piece further confirmed that the cage structure was preserved during the printing process (inset FIG. 1c). This method therefore enables the rapid deposition or 3D printing of porous materials with user-defined shape. In FIG. 1d, the parts were printed from a single projection layer, typically resulting in a thickness of about 1 mm (FIG. 6). Photo-rheology measurements (FIG. 8a) were performed under similar conditions (1 mm ink layer, 365 nm light source, 10 mW cm′ light power) as for the pattern in FIG. 1d. Although the light sources have slightly different wavelengths (385 nm vs. 365 nm), the absorption spectrum of TPO (FIG. 15) shows that absorbance values at those wavelengths are close enough to make the experiments comparable. In FIG. 8a, the photo-rheology measurement started with a 30 seconds stabilization period not displayed in the plot (i.e., UV irradiation starts at t=0 s). The PLIC ink showed a behavior similar to typical photo-polymerization of acrylate polymers. The gel point, defined as the crossover between the storage modulus (G′) and loss modulus (G″), was reached after about 15 s (light dose 0.15 J cm⁻²) of UV irradiation (inset FIG. 8a). In addition, the ink also shows a shear-thinning behavior (FIG. 16), with viscosities below 0.1 Pa·s for shear rates above 10 s⁻¹, well below the 5 Pa·s recommended viscosity for rapid recoating of ink layers, and even below the viscosities of a typical commercial 3D printing resin. These rheological properties allow for facile bed homogenization during printing and enable the fabrication of multilayer 3D structures (FIG. 1f), even with self-supporting features (FIG. 17). In FIG. 8b, the 3D structure was printed from 10 layers of 0.9 mm in thickness using a home built top-down setup (see Methods section for projector specifications). Although, the photo-rheology experiment (FIG. 8a) indicated a gel point at 0.15 J cm′, the light dose was set to 0.6 J cm′ for each layer (i.e., 1 min exposure time) to ensure good structural cohesion of the 3D part.

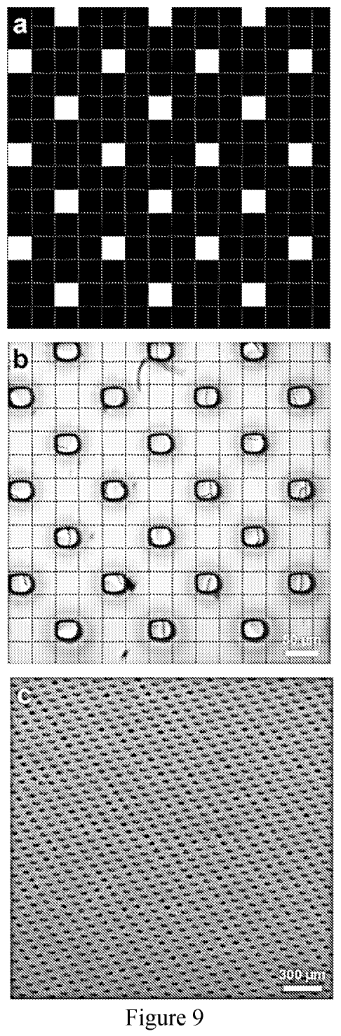

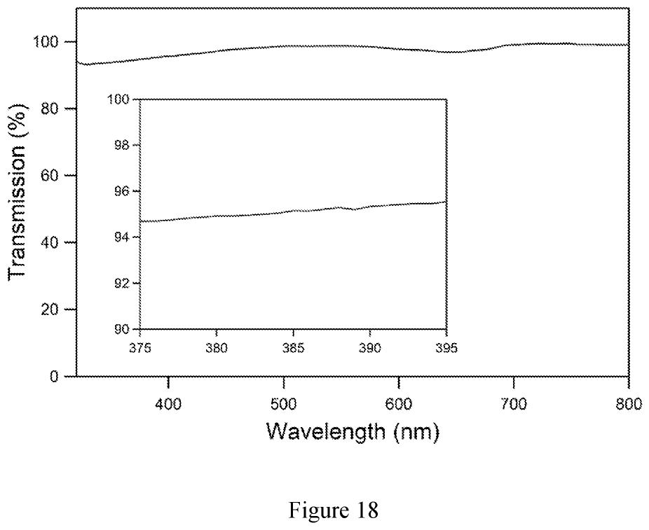

With the DLP technique, a possible material dependent limitation of the printing resolution would be light scattering from the ink itself. Analysis of the as-prepared ink by UV-vis spectrometry revealed no significant scattering around the projector wavelength of 385 nm, however, with about 95% transmission through 1 cm of ink (FIG. 18). Besides light scattering, the printing resolution for DLP is mostly hardware related. It mainly depends on the projected pixel size, which is a combination of DMD specifications and optics, and on the ability to accurately control the z position of the stage. The homemade setup that was use for the prints in FIGS. 1d and 8b and FIG. 17 is not optimized to achieve high resolution. In order to demonstrate that the highest resolutions can be reached using the PLIC inks reported here, w another DLP projector, namely a Wintech PRO4710 with an orthogonal DMD for a projected pixel size of 35.5 μm (see Methods section for projector specifications), was used. A thin layer of the PLIC ink was applied on a glass substrate and a pattern with single pixel resolution was projected, i.e., each of the white squares in FIG. 9a corresponds to an individual micromirror of the DMD. Observations with an optical microscope (FIG. 9b) showed high fidelity of the printed pixels with the pattern, evidencing that the hardware limit can be reached with the PLIC inks. In addition, this high resolution carries over to large areas (FIG. 9c).

Microstructure of the cage-based printed parts. The combination of PLIC inks and DLP printing provided several knobs to tune the internal microstructure of the printed parts, either by changing the ligand density or by varying the light dose. Large and free-standing honeycomb structures were printed from cages with different methacrylate ligand coverage (FIG. 1e, light dose 1.2 J cm⁻²). Interestingly, adjusting the ligand coverage allowed control of the printed material density. Comparison of parts fabricated from low and high ligand coverage PLICs revealed a positive correlation between methacrylate-silane ratio and density. For example, while sharing virtually identical dimensions, as precisely measured by confocal microscopy (FIG. 6), the parts in FIG. 1e weight 22.4 mg and 12.9 mg for the high coverage and low coverage samples, respectively. Thus, the high coverage part is about 1.7 times denser than the low coverage one. This is attributed to the difference in density to varying internal microstructures. These parts had similar specific surface areas, specifically 438 m² g⁻¹ and 450 m² g⁻¹ for the high and low coverage parts, respectively, as determined by the Brunauer-Emmett-Teller (BET) method. The hystereses of the nitrogen sorption measurements (FIG. 1f) show important differences in adsorption-desorption behavior. The broader hysteresis of the high coverage part suggests that access to mesopores is more restricted than in the case of the low coverage part, for which mesopore access is facilitated by the presence of more interstitial space and channels.

The optical properties of the printed structure are also sensitive to the methacrylate-silane ratio of the PLIC ink as illustrated by the photographs in FIG. 3a. While after drying the high coverage part appears relatively transparent, the low coverage one is more translucent due to light scattering by larger pores. To induce significant Mie scattering, these larger pores likely are a few tens of nanometers in size and correspond to interparticle pores because the intraparticle pores, i.e., cores of the cages, are less than 10 nm. These interparticle pores are most likely formed during the drying steps because the low ligand coverage ink remained scatter-free during the printing process as evidenced by the absence of in-plane overgrowth (FIG. 6). Since the parts have similar specific surface area regardless of the ligand coverage, these larger interparticle pores do not contribute significantly to the total surface area. Instead, the high specific surface areas mostly derive from the intraparticle pores of the cage structure and from the microporosity of silica itself. Varying the ligand coverage of cage-based PLIC inks therefore is a powerful tool to purposefully tune the porosity and internal structure of 3D printed objects. As a validation and reproducibility check, a PLIC ink was prepared by mixing the two cage samples in equivalent proportions. The isotherms of the resulting printed part, denoted as ‘mixed’ (FIG. 1f), showed an intermediate behavior between those obtained from the parent high or low coverage materials, hence offering an additional knob to tune the microstructure of these macroscopic objects.

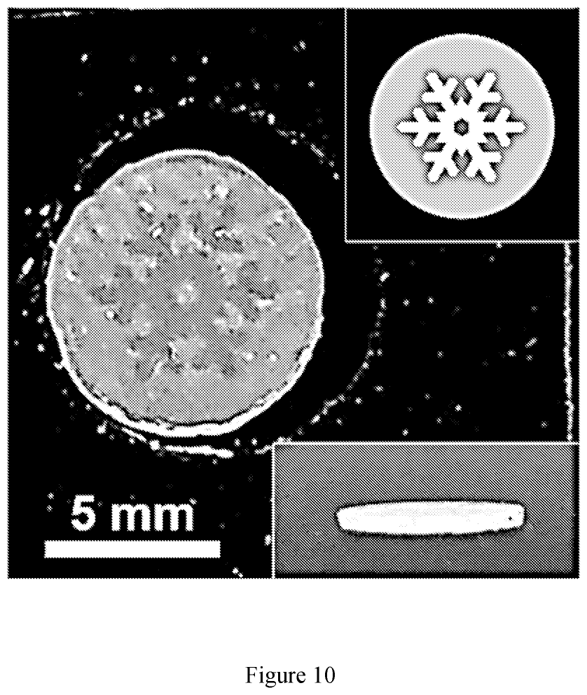

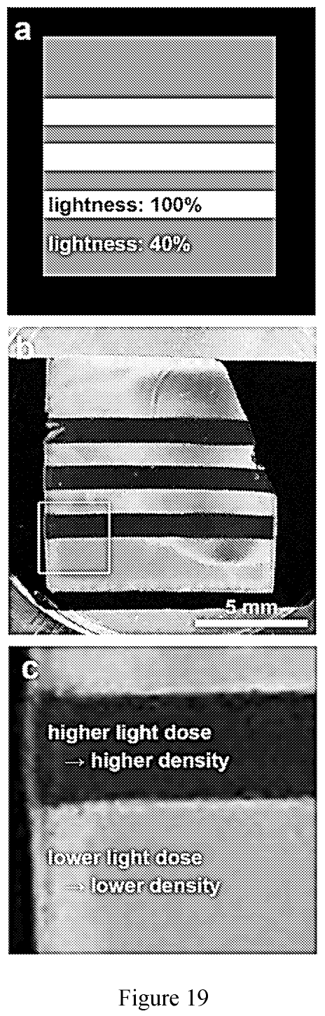

Alternatively to ligand density, the microstructure of the printed part can also be controlled as a function of the light dose. Indeed, using a DLP projector in video mode allows the generation of 8-bit greyscale patterns with important potential for the fabrication of materials with advanced properties. In FIG. 10, the single layer part was printed from a high ligand density ink using a greyscale pattern (top inset FIG. 10). The snowflake shape has a lightness of 100% (light dose 1.2 J cm′) and the surrounding disc has a lightness of 40% (light dose 0.2 J cm⁻²). Different light doses resulted in different density and optical transmission between the domains of the printed part. The domain that received a light dose of 1.2 J cm′ appears more translucent like the high ligand density part in FIG. 1e, whereas the domain that received a lower light dose exhibit much more light scattering due to more interparticle porosity as described above. The side view of the part confirmed that these differences did not result from thickness variations (bottom inset FIG. 10). The difference in light transmission between domains that received different light doses can be further evidenced from printed piece shown in FIG. 19. Thus, using greyscale patterns allows tuning the microstructure within an individual layer. This result illustrates one of the advantages of DLP printing as compared to other techniques, such as conventional photolithography using physical masks, which may not be able to modulate light doses throughout individual layers.

If desired, the organic components of the printed parts can be removed by calcining the structures (550° C. for 6 hours in air) to produce fully inorganic parts while preserving their macrostructure as well as their microstructure (FIG. 5). Calcination does lead to shrinkage, however, with the printed parts with high and low coverage resulting in a linear isotropic shrinkage of 17% and 12% (FIG. 6), together with a weight loss of 29% and 18%, respectively. This shrinkage and weight loss result from the thermal decomposition in air of the organic fragment of the methacrylate silane as well as, to some extent, from the further condensation of silanol groups, which releases one water molecule per Si—O—Si bond formed. The fact that printed parts retain their macroscopic shape after removal of the organics suggests that the formation of such Si—O—Si bridges between cages, promoted by either the thermal treatment or just the proximity between the cages, may play a role in material cohesion. The differences in shrinkage and weight loss between the high and low coverage samples are consistent with the different ratios of organic to inorganic components. Nitrogen sorption measurements before and after calcination showed very similar hysteresis shapes, suggesting that microstructure and mesopore access remained unchanged (FIG. 5). This is also supported by TEM observations of calcined parts, which showed very similar morphologies as before calcination (FIG. 14). In addition, the specific surface area increased to 646 m² g⁻¹ and 639 m² g⁻¹ for the high and low coverage materials, respectively (as compared to 438 m² g⁻¹ and 450 m² g⁻¹ before calcination).

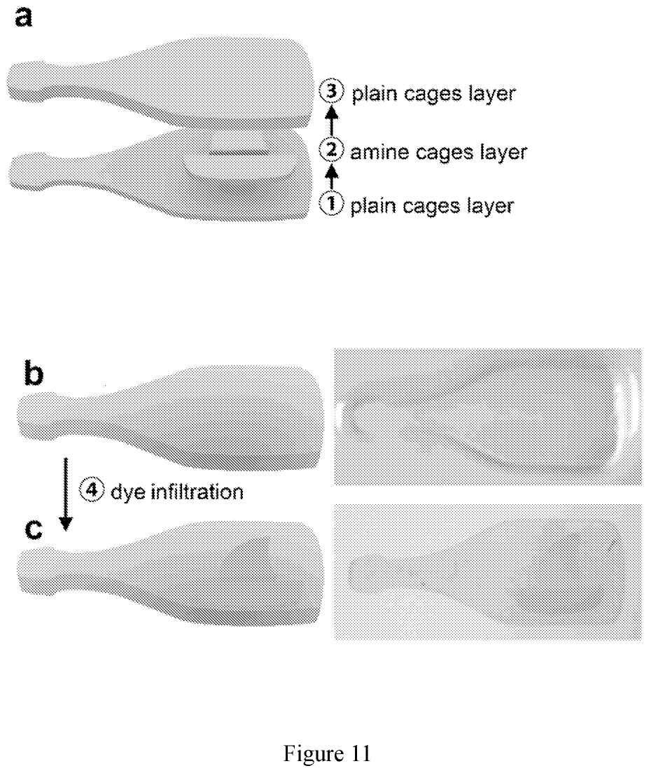

Positioning of functionalities in cage-based printed parts. The ability to directly print 3D shapes of porous materials with controlled structure, complemented by the large choice in possible cage surface functional groups, offers a versatile platform to realize advanced materials with innovative designs. Specific functionalities can thereafter be implemented with high spatial control in complex 3D architectures. As a proof-of-concept experiment (FIG. 2), methacrylate functionalized cages were modified post-synthesis, but prior to printing, with either thiol or amine groups, using (3-mercaptopropyl)trimethoxy-silane (MTPMS) or (3-aminopropyl)trimethoxy-silane (APTMS), resulting in two different inks. Two successive layers were printed on a modified glass substrate, to create a checkerboard pattern of about 1 mm in thickness, with spatially resolved thiol and amine functionalized tiles, simply by replacing the ink in the printer vat between the two layers (FIG. 2a,d). To improve adhesion of the printed parts and avoid moving of the pattern during ink replacement and intermediate washing steps, the glass substrate was functionalized with methacrylate groups prior to printing. Glass slides were first treated with a strong base to increase the surface density of silanol groups, and promote subsequent condensation with methacrylate-silane. This process was monitored by contact angle measurements (FIG. 4). An increase in the hydrophobicity of the substrate confirmed grafting with methacrylate groups. To demonstrate the spatially programmable chemical functionality of the two printed materials, the structure was immersed for 1 hour under gentle shaking (about 50 rpm) in 5 mL of a mixture of 200 nmol of tetramethylrhodamine-6 C2 maleimide (TMR-mal, pink dye in FIG. 2b,e) and 200 nmol of sulfo-cyanine5 succinimidyl ester (Cy5-NHS, blue dye in FIG. 2b,e) in DMSO. Thanks to the porous nature of the printed material (i.e., without requiring a calcination step), these two dyes penetrated the structure and selectively bound to specific tiles based on their respective click chemistry (FIG. 2c,f). This result is in line with nitrogen sorption results suggesting high pore accessibility. In order to demonstrate that larger molecules such as organic dyes can diffuse throughout the as-printed structures, a multilayer 3D object was fabricated in the shape of an amine functionalized ship printed inside a bottle (FIG. 11a). Thus, the functionalities in this part were fully surrounded by plain cages (i.e., only functionalized with methacrylate ligands). While initially invisible (FIG. 11b), the ship appeared after immersion in a solution of Cy5-NHS dye which was able to infiltrate the structure and bind selectively to the amine groups (FIG. 11c). This approach therefore enables the spatially pre-determined distribution of accessible functionalities throughout the whole volume of the printed part, rather than just on the surface. This is enabled by using cage structures and strongly benefits from the facts that (i) the methacrylate functionalization prior to template removal leaves the inner cage surface available for orthogonal functionalization and (ii) pore accessibility does not require any calcination step that would eliminate the functionalities. This approach may be extended to other click-type reactions as well as to biological applications, such as bioassays, for the detection of specific peptides or proteins for instance, where selectivity can be addressed as a function of chemical functionality as well as controlled porosity for size exclusion strategies. Since the porous particles are ultrasmall, and their inner and outer surfaces can be orthogonally functionalized prior to printing, this provides access to high information density materials, e.g., for multiplexed detection of various analytes and substrates.

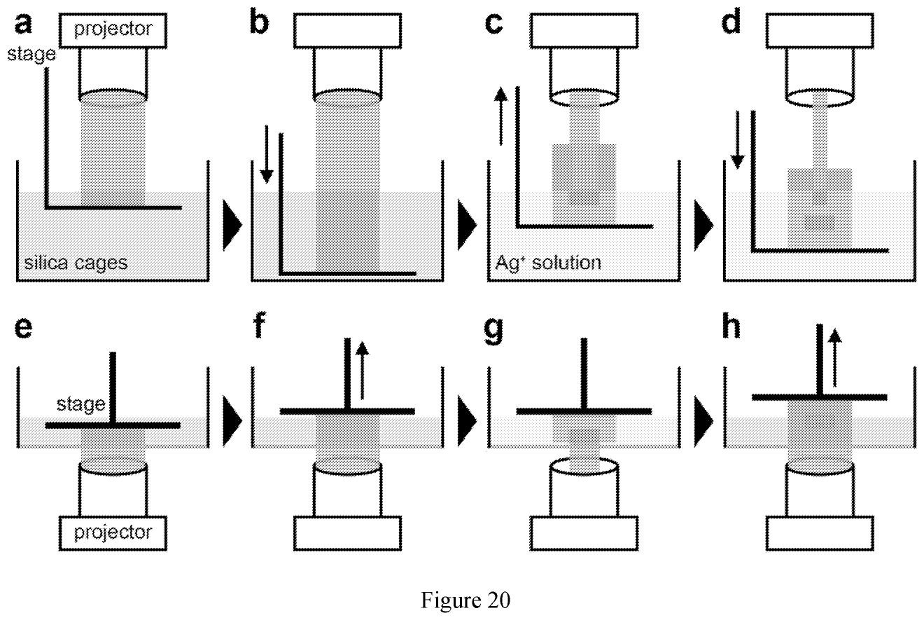

Internal printing in cage-based printed parts. Making use of the intrinsic and readily accessible porosity of the printed cage-based materials, we also propose an internal printing approach as another way of implementing functionalities within printed parts. Here, the pores of an already printed part serve as a scaffold for the subsequent printing of a second material directly within the first. To demonstrate this concept, a second metal structure was printed within the pores of a first printed silica structure. As illustrated in FIG. 3, a block of silica cages was first printed as described before and then soaked for 30 minutes in a solution of silver nitrate (0.1 M in 10:1 v/v ethanol:toluene), and two photoinitiators, namely TPO (0.05 M) and Darocur 1173 (0.5 M). In this case, TPO acts as a sensitizer for Darocur 1173, which serves as the electron donor for the reduction of Ag⁺ to Ag⁰. A light pattern was then projected in the form of three slabs to locally reduce silver (FIG. 3a-c). The silver slabs, visible by naked eye (FIG. 3d), were further observed by scanning electron microscopy (SEM), showing high contrast in backscattered electron based imaging (FIG. 3e), and matching well with elemental mapping by energy dispersive X-ray spectroscopy (EDS, FIG. 3f). The fact that silver is not quantitatively found outside of the slab pattern by EDS analysis indicates that detected silver inside the slab is indeed in the form of metallic Ag⁰ particles, which remained embedded within the pores, and unlike unreduced Ag⁺ ions, could not escape from the original silica block during washing steps. The analysis of the cross-section by energy dispersive X-ray spectroscopy (EDS) also confirmed the presence of silver inside the volume of the slab (FIG. 7). The internal printing of silver structures is demonstrated here in a single thick layer. Several approaches can be conceived for its implementation in multilayer prints, either by changing the solution in the ink vat between each layer in a bottom-up projection setup or by progressively re-immersing a fully printed object in a top-down projection setup (see schematics in FIG. 20). The cure depth (or reduction depth in the case of a metal structure) can then be controlled by using a light absorber or by tuning the light dose, hence offering free-form capability on the second material in both xy and z directions. Alternatively, one can also envision using femtosecond lasers to print the guest material with high spatial resolution inside a printed cage-based mesoporous part, similar to the direct laser writing of metal and metal halide structures in glasses or polymer gels.

Discussion.

The 3D printing of a second material within a 3D printed mesoporous silica block opens a broad and versatile opportunity space. Through this approach, the two materials are entangled with each other, which means that the structure of the scaffold or host material will influence the structure and therefore properties of the guest material. This entanglement also allows for interactions, such as charge transport, between the two materials. These interactions may even benefit from the high interfacial area between them. Deliberately varying the porosity of the silica host and hence the interconnectivity of the guest materials, thereafter is expected to modulate charge and ion transport properties throughout the printed structure. Filling the cages with electrochemically or optically active guest materials further creates an interesting class of ‘confined but connected’ materials with important practical implications, e.g., for the design and discovery of battery or photovoltaic materials with programmable mesostrucure and hierarchical architectures. This approach can readily be extended to a large variety of materials (e.g., semiconductors and metal oxides) offering a wealth of unique properties. For instance, printing two different catalytic materials within a porous scaffold could result in a highly tunable platform with controlled symmetry and flux for tandem catalysis applications. The whole 3D printing toolbox can thereafter be put to practice for the internal printing and positioning of active centers within the host scaffold with a great degree of freedom.

In conclusion, the design of PLIC inks based on functional porous nanomaterials, and their combination with 3D printing techniques, such as DLP, offers an innovative playground to engineer ever more sophisticated devices with increased capabilities. By formulating inks from intrinsically porous nano-sized building blocks, we performed first proof-of-principle experiments for the direct printing of mesoporous parts, which in turn enabled an internal printing approach. The versatile functionalization of the silica cages further allowed to control the internal microstructure and functionalities of the printed structures. This approach may enable a number of device architectures with important potential for sensing, catalytic, or energy applications, which so far were not directly accessible with conventional material processing techniques.

Methods.

Methacrylate functionalized silica cages. Silica cage synthesis was adapted from a previously reported method. The synthesis was scaled up as compared to the original method, simply by multiplying all molar quantities by a factor 30. In a 500 mL flask, 3.75 g of CTAB was dissolved in 300 mL of water at 30° C. 300 μl of ammonia (2 M in ethanol) and 3 mL of mesitylene were added and the mixture was allowed to stir (800 rpm) for 4 hours. 3 mL of TMOS was then added slowly and the reaction was left to proceed for one day at 30° C. For initial experiments (samples denoted as high ligand coverage materials), 3 mL of 3-(trimethoxysilyl)propyl methacrylate (methacrylate-silane) was added slowly and the reaction was left to proceed for another day. For samples denoted as low ligand coverage materials, only 1.2 mL of methacrylate-silane was added. For purification of the functionalized cages, the synthesis solution was first dialyzed in 2 L of water:ethanol:acetic acid (v/v 500:500:7) under slow stirring, changing the solution 4 times over the course of 2 days, then dialyzed in 2 L of water, changing the solution 3 times over the course of 4 days. The cages were then collected by centrifugation (7000 g, 10 min) and redispersed in 150 mL of ethanol. The cages were further washed using spin filters (VivaSpin, 100 kDa MWCO) and centrifugation (2400 g), until concentrated to a total volume of 4.5 mL. The cage solution was finally diluted with 4.5 mL of toluene and used as made. The two-fold dilution with toluene was found to prevent gelation of the ink due to uncondensed silanol groups in sol-gel synthesized silica, and hence increased ink shelf life. Toluene was chosen to also help dissolution of the photoinitiator in the ink. Without intending to be bound by any particular theory, it is considered that that based results of independent studies using the same photoinitiator, other solvents may be used such as propylene glycol monomethyl ether acetate (PGMEA).

In situ dye functionalization of cages. For the direct fluorescent labeling of cages during the synthesis (FIG. 1d), the synthesis was downscaled 15 times. A dye-silane conjugate was prepared one day prior to the synthesis by mixing 0.45 μmol of TMR-mal and 1.74 μL of MPTMS in 67 μL of dimethyl sulfoxide (DMSO) under inert atmosphere. This dye-silane conjugate was added immediately after the TMOS addition during the cage synthesis. The remainder of the procedure was kept unchanged.

Thiol and amine functionalization. For the post-synthesis modification of cages, either 83.2 μL of MTPMS or 78.4 μL of APTMS (for thiol and amine functionalization, respectively) was added to 4 mL of the cage solution. The mixture was allowed to stir for 3 days at room temperature and then used as is.

Modification of glass substrates. For the preparation of methacrylate functionalized substrates, cover glass slides (1.8×1.8 cm) were first activated by soaking overnight in a petri dish containing 5 mL of a 0.2 M NaOH solution in water. The substrates were then rinsed with water and soaked another night in a mixture of 3.5 ml ethanol, 0.5 mL NH₄OH (28-30% in water) and 1 mL of methacrylate-silane. The substrates were finally rinsed with ethanol and dried with nitrogen.

3D printing. PLIC inks for printing were formulated by dissolving the photoinitiator, diphenyl(2,4,6-trimethylbenzoyl) phosphine oxide (7 mM, 0.3 wt %), in the silica cage solutions. The inks were bubbled with nitrogen for 2 minutes before usage to remove oxygen. Except for the high resolution print (FIG. 9), all samples were printed with a homemade top-down digital light processing (DLP) 3D printer using a Wintech PRO4500 projector based on a DLP4500 WXGA (912×1140) diamond pixel DMD, equipped with a 92 mm working distance lens (projected pixel size of 50 μm) and a 385 nm LED (output power 10 mW cm⁻²). For printing on glass substrates (FIGS. 1d, 2, and 11), substrates were placed on top of a fitted piece of Si wafer in a 1.9×1.9 cm square shaped Teflon dish. 280 μL of the ink was added to the dish and the part was printed as a single layer by projecting the light pattern for 2 minutes. For the printing of free-standing parts (FIGS. 1a and b, FIG. 3, FIG. 5, FIG. 8b, FIG. 10, FIG. 17, and FIG. 19), the samples were printed directly on top of the Si wafer, resulting in easy detachment after drying. Printed samples were washed with methanol for 24 hours and dried with supercritical carbon dioxide dryer (Leica CPD300). For the high resolution print (FIG. 9), a thin layer of ink was applied on a glass slide using a TQC Sheen cube applicator with a gap of 38 μm, and a single pixel pattern was projected using a Wintech PRO4710 projector based on a DLP4710 1080p (1920×1080) orthogonal pixel DMD, equipped with a 92 mm working distance lens (projected pixel size of 35.5 μm) and a 385 nm LED (output power 10 mW cm⁻²). In order to prevent quick drying of the ink in such very thin layers, the methacrylate functionalized cages were dispersed in a mixture of ethanol:N-methyl-2-pyrrolidone (1:1 vol %) instead of ethanol:toluene. The cage concentration in the ink was kept the same as for other inks.

Characterization methods. TEM images were acquired using a FEI Tecnai T12 Spirit microscope operated at an acceleration voltage of 120 kV. For the TEM analysis of the methacrylate functionalized silica cages (FIG. 1b), the as-prepared solution was diluted by a factor of one thousand in toluene, then 10 μl of this solution was dropped onto a carbon coated TEM grid and the excess solution was blotted with a filter paper. For the TEM analysis of the printed part (FIG. 1c and FIG. 14), small pieces were roughly crushed, then the resulting powder was lightly sprinkled on a carbon coated TEM grid and excess material was removed by gentle air blowing. SEM (backscattered electron and secondary electron) images and EDS elemental maps were acquired using a Tescan Mira3 field-emission SEM operated at an acceleration voltage of 10 kV. Nitrogen sorption isotherms were acquired using a Micromeritics ASAP 2020. Confocal microscopy images for dimensional analyses were acquired using a Keyence VK-X260 laser-scanning confocal microscope. FTIR spectra were acquired using a Perkin Elmer Spectrum 1000 spectrometer. UV-vis transmission spectra were acquired using a Perkin Elmer Lambda 365 spectrometer. Contact angle measurements were performed using a Rame-Hart 500 Goniometer, with MilliQ water dropped on either as-received glass slides or freshly prepared modified substrates. Rheology measurements were performed with a DHR3 rheometer from TA Instruments, using parallel plates of 20 mm in diameter and an Omnicure Series 1500 light source with a 365 nm filter (output power 10 mW cm⁻²). Storage and loss moduli were measured at a shear rate of 60 s⁻¹. Optical microscope images were acquired using a Leitz Laborlux microscope with a 10× air objective.

Although the present disclosure has been described with respect to one or more particular examples, it will be understood that other examples of the present disclosure may be made without departing from the scope of the present disclosure.

1. A photoreactive composition comprising: a plurality of reactive components, the individual reactive components comprising: a silica cage core having a longest dimension of 5 to less than 50 nm, and one or more photoreactive ligand(s), wherein the photoreactive ligand(s) is/are bound to the silica cage core by one or more chemical bonds.

2. The photoreactive composition of claim 1, wherein the photoreactive ligand(s) is/are chosen from acrylate ligands, alkene ligands, and combinations thereof.

3. The photoreactive composition of claim 1, wherein the at least a portion of or all of the photoreactive ligands is/are chosen from functionalized amino acid groups, glutathione groups, biotin groups, nitrilotriacetic acid (NTA) groups, iminodiacetic acid (IDA) groups, polyadenylic acid (poly A) groups, nucleotide groups, phospho-amino acid groups, boronic acid groups, and combinations thereof.

4. The photoreactive composition of claim 1, further comprising one or more photoinitiator(s) chosen from free-radical photoinitiators, cationic photoinitiators, nanoparticle-based photoinitiators, photo-acid generators, and combinations thereof.

5. The photoreactive composition of to claim 4, wherein the free radical photoinitiator(s) is/are chosen from diphenyl(2,4,6-trimethylboenzoyl phosphine oxide), phosphine oxide, phenyl bis(2, 4, 6-trimethyl benzoyl), bis [2,6-difluoro-3-(1H-pyrrol-1-yl) phenyljtitanium, anthraquinone-2-sulfonic acid, 4-benzoylbiphenyl, 4,4′-bis(diethylamino) benzophenone, 2-benzyl-2-(dimethylamino)-4′-morpholinobutyrophenone, 4,4′-bis(dimethylamino) benzophenone, 4-(dimethylamino) benzophenone, 2-Hydroxy-2-methyl-1-phenyl-propan-1-one, and combinations thereof; the cationic photoinitiator(s) is/are chosen from diphenyliodonium hexafluorophosphate, (4-Iodophenyl)diphenylsulfonium triflate, (4-tert-Butylphenyl)diphenylsulfonium triflate, and combinations thereof; the nanoparticle-based photoinitiator(s) is/are chosen from quantum dots, zinc oxide nanoparticles, and combinations thereof; the photo-acid generators are chosen from (4-methylthiophenyl) methyl phenyl sulfonium triflate, sodium 1,2,3,4-thiatriazole-5-thiolate, tris(diphenyliodonium), 9-hydroxy-pyrene-1,4, 6-tri sulfonate, and combinations thereof and combinations thereof.

6. The photoreactive composition of claim 1, further comprising one or more crosslinker(s).

7. The photoreactive composition of claim 6, wherein the one or more crosslinker(s) is/are chosen from di- to multi-thiol groups, di- to multi-acrylate groups, and combinations thereof.

8. The photoreactive composition of claim 1, wherein the composition further comprises one or more oligomer(s) with a molecular weight from 100 to 5000 amu.

9. The photoreactive composition of claim 8, wherein the one or more oligomer(s) is/are chosen from oligomers and polymers of epoxy acrylates, aliphatic urethane acrylates, aromatic urethane acrylates, ester acrylates, acrylic acrylates, and combinations thereof.

10. The photoreactive composition of claim 1, further comprising one or more solvent(s).

11. The photoreactive composition according to claim 10, wherein the solvent(s) is/are chosen from aromatic solvents, aliphatic solvents, polyethers or oligoethers, halogenated solvents, and combinations thereof.

12.-47. (canceled)

48. The photoreactive composition of claim 1, wherein the silica cage core has a longest dimension of 10 to less than 50 nm.

49. The photoreactive composition of claim 1, wherein the silica cage core comprises one or more apertures or windows having a longest dimension of 1 to 10 nm.

50. The photoreactive composition of claim 1, wherein the silica nanocages comprise surface polygons selected from 3³4³, 4⁴5⁴, 4³5⁶6³, 3³4³5⁹, 5¹² (dodecahedral), 5¹²6², 4⁶6⁸ 5¹²6³, 5¹²6⁴, 4³5⁹6²7³, 5¹²6⁸, and 5¹²6²⁰, wherein an exponent describes how often a polygon appears on the surface of the cage.

51. The photoreactive composition of claim 1, wherein the silica nanocages comprise symmetric cage structures, selected from dodecahedral, icosahedral, cubic, hexanol, tetrahedral, octahedral, and buckyball-like cages.

52. The photoreactive composition of claim 1, wherein the silica nanocages comprise a surface area of 500 to 800 m²/g.

53. The photoreactive composition of claim 1, wherein the photoreactive ligands comprise one or more chelating group(s) and one or more photoreactive group(s).

54. The photoreactive composition of claim 53, wherein the one or more chelating group(s) of the photoreactive ligands is/are selected from thiol/thiolate groups, carboxylic acid/carboxylate groups, amines, silanol groups, and any combination thereof, and wherein the one or more photoreactive group of the photoreactive ligands are selected from carbon-carbon double bonds, acrylate groups, alkyne groups, thiol groups, ester group, heterocyclic group, and any combination thereof.

55. The photoreactive composition of claim 53, wherein at least a portion of an exterior surface and/or at least a portion of an interior surface of the silica nanocages are further functionalized with polyethylene glycol or a fluorescent dye.

56. A three-dimensional (3D) article of manufacture made by photopolymerizing a photoreactive composition of claim 1, wherein the photoreactive composition comprises one or more printable groups in the individual reactive components.
